(19) United States
(12) Patent Application Publication
(10) Pub. No.: US 2012/0229667 A1
(43) Pub. Date: Sep. 13, 2012

(54) IMAGE-SHOOTING DEVICE

(75) Inventor: Norikazu TSUNEKAWA, Osaka City (JP)

(73) Assignee: SANYO ELECTRIC CO., LTD., Moriguchi City (JP)

(21) Appl. No.: 13/414,645

(22) Filed: Mar. 7, 2012

(30) Foreign Application Priority Data
Mar. 7, 2011 (JP) 2011-049128

(51) Int. Cl. H04N 5/228

(52) U.S. Cl. 348/222.1; 348/E05.031

(57) ABSTRACT

An image-shooting device has an image sensor having a plurality of photoreceptive pixels, and a signal processing section which generates the image data of an output image from the photoreceptive pixel signals within an extraction region on the image sensor. The signal processing section controls the spatial frequency characteristic of the output image according to an input pixel number, which is the number of photoreceptive pixels within the extraction region, and an output pixel number, which is the number of pixels of the output image.

### CROSS-REFERENCE TO RELATED APPLICATIONS

This nonprovisional application claims priority under 35 U.S.C. §119(a) on Patent Application No. 2011-049128 filed in Japan on Mar. 7, 2011, the entire contents of which are hereby incorporated by reference.

### BACKGROUND OF THE INVENTION

1. Field of the Invention

The present invention relates to image-shooting devices such as digital cameras.

2. Description of Related Art

There have been proposed methods of producing an output image by use of only photoreceptive pixel signals within a region that is part of the entire photoreceptive pixel region of an image sensor. These methods are by and large like the one shown in FIGS. 28A and 28B.

The method shown in FIGS. 28A and 28B proceeds as follows. An extraction frame (extraction region) having a size commensurate with a user-specified zoom magnification is set on an image sensor 33. From the photoreceptive pixel signals within the extraction frame, D_{IN}-megapixel image data is obtained, and thereafter the D_{IN}-megapixel image is reduced to obtain predetermined D_{OUT}-megapixel (for example, 2-megapixel) image data as the image data of an output image. Here, D_{IN}≧D_{OUT}, and the higher the RAW zoom magnification, the closer D_{IN} is to D_{OUT}. Accordingly, as the RAW zoom magnification increases, the extraction frame becomes increasingly small, and the angle of view of the output image becomes increasingly small. Thus, by increasing the RAW zoom magnification, it is possible to obtain an effect of virtually increasing the optical zoom magnification without degradation in image quality. In addition, the amount of image data can be reduced in initial stages of signal processing, and this makes RAW zooming particularly advantageous in moving image shooting that requires high frame rates.

In FIG. 28A, the images 901 and 902 are respectively an 8-megapixel input image and a 2-megapixel output image that are obtained when the RAW zoom magnification is relatively low. In FIG. 28B, the images 911 and 912 are respectively a 2-megapixel input image and a 2-megapixel output image that are obtained when the RAW zoom magnification is relatively high (when the RAW zoom magnification is equal to the upper-limit magnification). That is, FIG. 28A shows a case where √(D_{OUT}/D_{IN})=0.5, and FIG. 28B shows a case where √(D_{OUT}/D_{IN})=1.0.

The maximum spatial frequency that can be expressed in the 2-megapixel output image 902 is lower than that in the 8-megapixel input image 901. On the other hand, the maximum spatial frequency that can be expressed in the 2-megapixel output image 912 is similar to that in the 2-megapixel input image 911. In one conventional method, however, irrespective of the ratio (D_{OUT}/D_{IN}), that is, irrespective of the RAW zoom magnification, the same signal processing (for example, demosaicing processing) is performed.

For the purpose of noise elimination, there have been proposed technologies of applying filtering to the input image (RAW data).

In a case where the signal processing performed on the input image or the output image is of a kind suitable for a state where √(D_{OUT}/D_{IN})=1, when √(D_{OUT}/D_{IN}) is actually equal to 0.5, the high-frequency spatial frequency components that can be expressed in the 8-megapixel input image 901 but that cannot be expressed in the 2-megapixel output image 902 may mix with the 2-megapixel output image 902, causing aliasing in the 2-megapixel output image 902. Aliasing appears as false color or noise.

Aliasing can be suppressed by incorporating smoothing (low-pass filtering) in the signal processing. Incorporating uniform smoothing in the signal processing, however, results in unnecessarily smoothing signals when √(D_{OUT}/D_{IN})=1, producing an output image with lack in resolution (resolving power).

Needless to say, it is beneficial to suppress aliasing on one hand and suppress lack in resolution on the other hand with a good balance.

Expectations are high for achieving both suppression of aliasing and suppression of lack in resolution with a good balance.

### SUMMARY OF THE INVENTION

According to the present invention, an image-shooting device is provided with: an image sensor having a plurality of photoreceptive pixels; and a signal processing section which generates the image data of an output image from the photoreceptive pixel signals within an extraction region on the image sensor. Here, the signal processing section controls the spatial frequency characteristic of the output image according to an input pixel number, which is the number of photoreceptive pixels within the extraction region, and an output pixel number, which is the number of pixels of the output image.

### BRIEF DESCRIPTION OF THE DRAWINGS

FIG. 1 is a schematic overall block diagram of an image-shooting device embodying the invention;

FIG. 2 is an internal configuration diagram of the image-sensing section in FIG. 1;

FIG. 3A is a diagram showing the array of photoreceptive pixels in an image sensor, and FIG. 3B is a diagram showing the effective pixel region of an image sensor;

FIG. 4 is a diagram showing the array of color filters in an image sensor;

FIG. 5 is a diagram showing the relationship among an effective pixel region, an extraction frame, and a RAW image;

FIG. 6 is a block diagram of part of the image-shooting device;

FIGS. 7A and 7B are diagrams showing the relationship among an extraction frame, a RAW image, and a conversion result image;

FIG. 8 is a block diagram of part of the image-shooting device;

FIG. 9 is a diagram showing a YUV image and a final result image;

FIG. 10 is a diagram showing an example of the relationship among overall zoom magnification, optical zoom magnification, electronic zoom magnification, and RAW zoom magnification;

FIG. 11 is a diagram showing the relationship between a pixel of interest and a target pixel;

FIGS. 12A and 12C are diagrams showing filters used in color interpolation processing, and FIGS. 12B and 12D are diagrams showing the values of the photoreceptive pixel signals corresponding to the individual elements of the filters;

FIGS. 13A to 13C are diagrams showing filters used to generate G signals in basic color interpolation processing;

FIGS. 14A to 14D are diagrams showing filters used to generate R signals in basic color interpolation processing;

FIGS. 15A to 15D are diagrams showing filters used to generate B signals in basic color interpolation processing;

FIG. 16 is a diagram showing part of the image-shooting device;

FIG. 17A is a diagram showing an input RAW image and an output RAW image under the condition that the RAW zoom magnification is 0.5 times, and FIGS. 17B and 17C are diagrams showing the modulation transfer functions of the input and output RAW images (with no degradation due to blur assumed);

FIG. 18A is a diagram showing an input RAW image and an output RAW image under the condition that the RAW zoom magnification is 1.0 time, and FIGS. 18B and 18C are diagrams showing the modulation transfer functions of the input and output RAW images (with no degradation due to blur assumed);

FIGS. 19A and 19B are diagrams showing filters used to generate G signals in color interpolation processing in Example 1 of the present invention;

FIGS. 20A and 20B are diagrams showing filters used to generate G signals in color interpolation processing in Example 1 of the present invention;

FIGS. 21A and 21B are diagrams showing filters used to generate R signals in color interpolation processing in Example 2 of the present invention;

FIG. 22A is a diagram showing an input RAW image and an output RAW image under the condition that the RAW zoom magnification is 0.5 times, and FIGS. 22B and 22C are diagrams showing the modulation transfer functions of the input and output RAW images (with degradation due to blur assumed);

FIG. 23A is a diagram showing an input RAW image and an output RAW image under the condition that the RAW zoom magnification is 1.0 time, and FIGS. 23B and 23C are diagrams showing the modulation transfer functions of the input and output RAW images (with degradation due to blur assumed);

FIG. 24 is a block diagram of part of the image-shooting device;

FIG. 25 is a diagram showing filters used to generate G signals in color interpolation processing in Example 3 of the present invention;

FIG. 26 is a block diagram of part of the image-shooting device according to Example 4 of the present invention;

FIG. 27 is a modified block diagram of part of the image-shooting device according to Example 4 of the present invention;

FIGS. 28A and 28B are diagrams illustrating an outline of RAW zooming as conventionally practiced.

### DETAILED DESCRIPTION OF PREFERRED EMBODIMENTS

Hereinafter, examples of how the present invention is embodied will be described specifically with reference to the accompanying drawings. Among the different drawings referred to in the course, the same parts are identified by the same reference signs, and in principle no overlapping description of the same parts will be repeated. Throughout the present specification, for the sake of simple notation, particular data, physical quantities, states, members, etc. are often referred to by their respective reference symbols or signs alone, with their full designations omitted, or in combination with abbreviated designations. For example, while the RAW zoom magnification is identified by the reference symbol ZF_{RAW}, the RAW zoom magnification ZF_{RAW} may also be referred to as the magnification ZF_{RAW} or, simply, ZF_{RAW}.

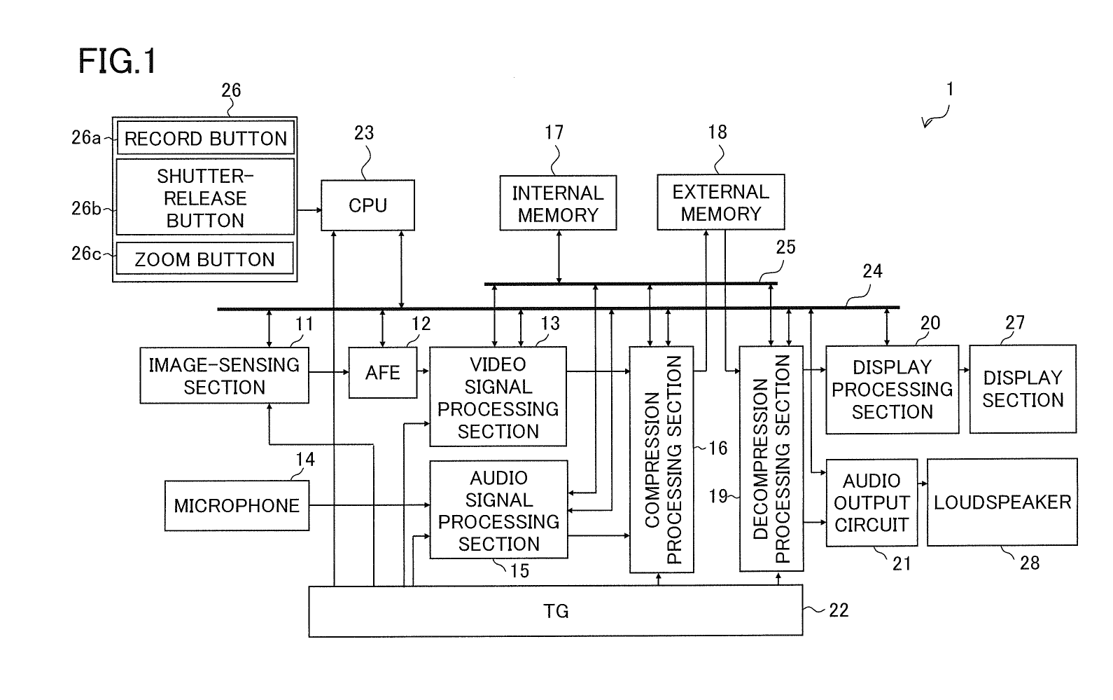

FIG. 1 is an overall block diagram of an image-shooting device 1 embodying the invention. The image-shooting device 1 includes blocks identified by the reference signs 11 to 28. The image-shooting device 1 is a digital video camera that is capable of shooting moving and still images and that is capable of shooting a still image simultaneously while shooting a moving image. The different blocks within the image-shooting device 1 exchange signals (data) via busses 24 and 25. A display section 27 and/or a loudspeaker 28 may be thought of as being provided on an external device (not shown) separate from the image-shooting device 1.

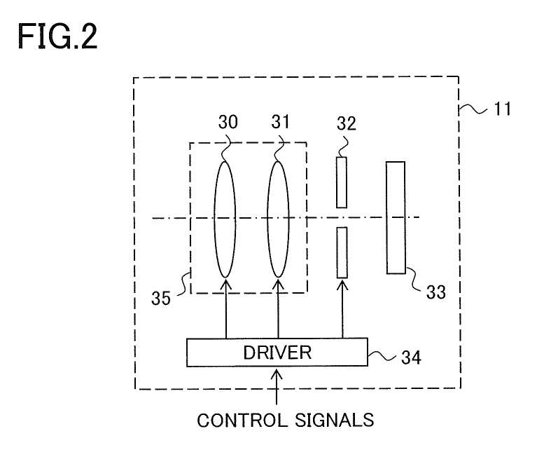

An image-sensing section 11 shoots a subject by use of an image sensor. FIG. 2 is an internal configuration diagram of the image-sensing section 11. The image-sensing section 11 includes an optical system 35, an aperture stop 32, an image sensor (solid-state image sensor) 33 that is a CCD (charge-coupled device) or CMOS (complementary metal oxide semiconductor) image sensor or the like, and a driver 34 for driving and controlling the optical system 35 and the aperture stop 32. The optical system 35 is composed of a plurality of lenses including a zoom lens 30 for adjusting the angle of view of the image-sensing section 11 and the a focus lens 31 for focusing. The zoom lens 30 and the focus lens 31 are movable along the optical axis. According to control signals from a CPU 23, the positions of the zoom lens 30 and the focus lens 31 within the optical system 35 and the aperture size of the aperture stop 32 are controlled.

The image sensor 33 is composed of a plurality of photoreceptive pixels arrayed both in the horizontal and vertical directions. The photoreceptive pixels of the image sensor 33 photoelectrically convert the optical image of a subject incoming through the optical system 35 and the aperture stop 32, and outputs the resulting electrical signal to an AFE (analog front end) 12.

The AFE 12 amplifies the analog signal output from the image sensor 33 (photoreceptive pixels), converts the amplified analog signal into a digital signal, and outputs the digital signal to a video signal processing section 13. The amplification factor of signal amplification in the AFE 12 is controlled by a CPU (central processing unit) 23. The video signal processing section 13 applies necessary image processing to the image represented by the output signal of the AFE 12, and generates a video signal representing the image having undergone the image processing. A microphone 14 coverts the ambient sound around the image-shooting device 1 into an analog audio signal, and an audio signal processing section 15 convers the analog audio signal into a digital audio signal.

A compression processing section 16 compresses the video signal from the video signal processing section 13 and the audio signal from the audio signal processing section 15 by use of a predetermined compression method. An internal memory 17 is a DRAM (dynamic random-access memory) or the like, and temporarily stores various kinds of data. An external memory 18 as a recording medium is a non-volatile memory such as semiconductor memory or a magnetic disk, and records the video and audio signals having undergone the compression by the compression processing section 16.

A decompression processing section 19 decompresses the compressed video and audio signal read out from the external memory 18. The video signal having undergone the decompression by the decompression processing section 19, or the video signal from the video signal processing section 13, is fed via a display processing section 20 to a display section 27, which is a liquid crystal display or the like, to be displayed as an image. The audio signal having undergone the decompression by the decompression processing section 19 is fed via an audio output circuit 21 to a loudspeaker 28 to be output as sounds.

A TG (timing generator) 22 generates timing control signals for controlling the timing of different operations in the entire image-shooting device 1, and feeds the generated control signals to the relevant blocks within the image-shooting device 1. The timing control signals include a vertical synchronizing signal Vsync and a horizontal synchronizing signal Hsync. A CPU 23 comprehensively controls the operation of different blocks within the image-shooting device 1. An operation section 26 includes, among others, a record button 26a for entering a command to start and end the shooting and recording of a moving image, a shutter-release button 26b for entering a command to shoot and record a still image, and a zoom button 26c for specifying the zoom magnification, and accepts various operations by the user. How the operation section 26 is operated is communicated to the CPU 23. The operation section 26 may include a touch screen.

The image-shooting device 1 operates in different modes including a shooting mode in which it can shoot and record images (still or moving images) and a playback mode in which it can play back and display on the display section 27 images (still or moving images) recorded on the external memory 18. According to operation on operation section 26, the different modes are switched. Unless otherwise stated, the following description deals with the operation of the image-shooting device 1 in shooting mode.

In shooting mode, a subject is shot periodically, at predetermined frame periods, so that shot images of the subject are acquired sequentially. A video signal representing an image is also referred to as image data. Image data corresponding to a given pixel may also be referred to as a pixel signal. The size of an image, or of an image region, is also referred to as an image size. The image size of an image of interest, or of an image region of interest, can be expressed in terms of the number of pixels constituting the image of interest, or belonging to the image region of interest.

In the present specification, the image data of a given image is occasionally referred to simply as an image. Accordingly, for example, generating, acquiring, recording, processing, modifying, editing, or storing a given image means doing so with the image data of that image. Compression and decompression of image data are not essential to the present invention; therefore compression and decompression of image data are disregarded in the following description. Accordingly, for example, recording compressed image data of a given image is referred to simply as recording image data, or recording an image.

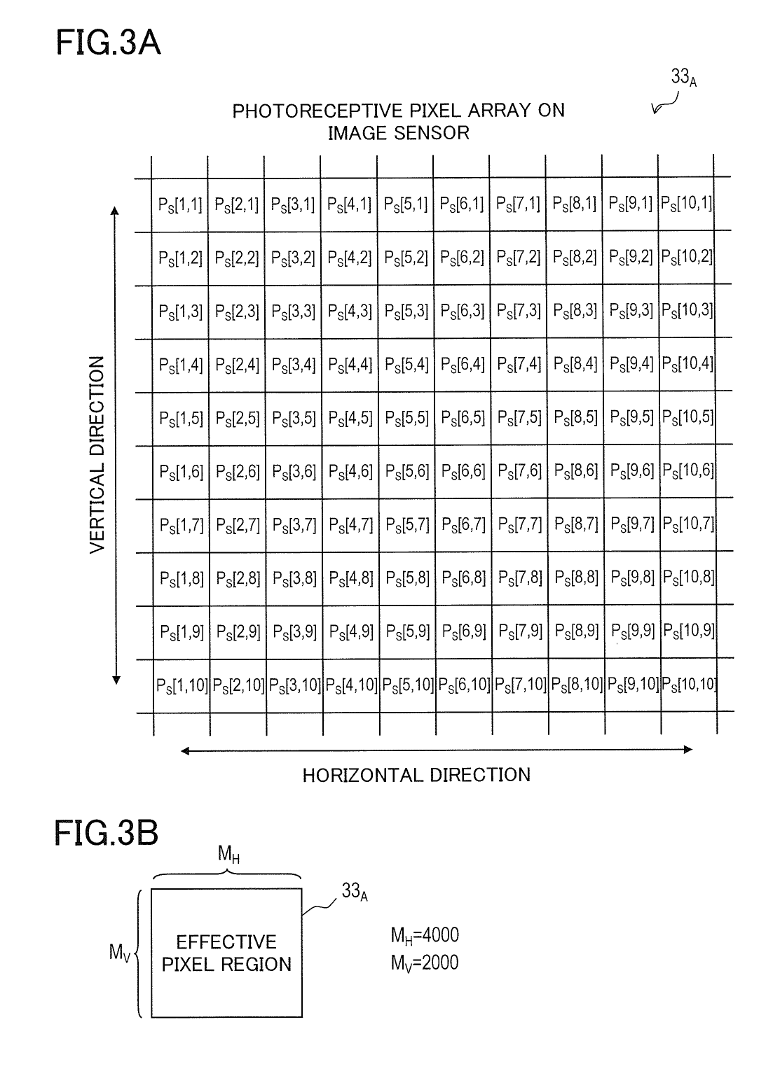

FIG. 3A shows the array of photoreceptive pixels within an effective pixel region 33_{A} of the image sensor 33. As shown in FIG. 3B, the effective pixel region 33_{A} of the image sensor 33 is rectangular in shape, with one vertex of the rectangle taken as the origin of the image sensor 33. The origin is assumed to be at the upper left corner of the effective pixel region 33_{A}. As shown in FIG. 3B, the effective pixel region 33_{A} is formed by a two-dimensional array of photoreceptive pixels of which the number corresponds to the product (M_{H}×M_{V}) of the effective number of pixels M_{H} in the horizontal direction and the effective number of pixels M_{V} in the vertical direction on the image sensor 33. M_{H} and M_{V} are each an integer of 2 or more, taking a value, for example, of the order of several hundred to several thousand. In the following description, for the sake of concreteness, it is assumed that M_{H}=4,000 and M_{V}=2,000. Moreover, 1,000,000 pixels is also referred to as one megapixel. Accordingly, (4,000×2,000) pixels is also referred to as 8 megapixels.

Each photoreceptive pixel within the effective pixel region 33_{A} is represented by P_{S}[x, y]. Here, x and y are integers. In the image sensor 33, the up-down direction corresponds to the vertical direction, and the left-right direction corresponds to the horizontal direction. In the image sensor 33, the photoreceptive pixels adjacent to a photoreceptive pixel P_{S}[x, y] at its right, left, top, and bottom are P_{S}[x+1, y], P_{S}[x−1, y], P_{S}[x, y−1], P_{S}[x, y+1] respectively. Each photoreceptive pixel photoelectrically converts the optical image of the subject incoming through the optical system 35 and the aperture stop 32, and outputs the resulting electrical signal as a photoreceptive pixel signal.

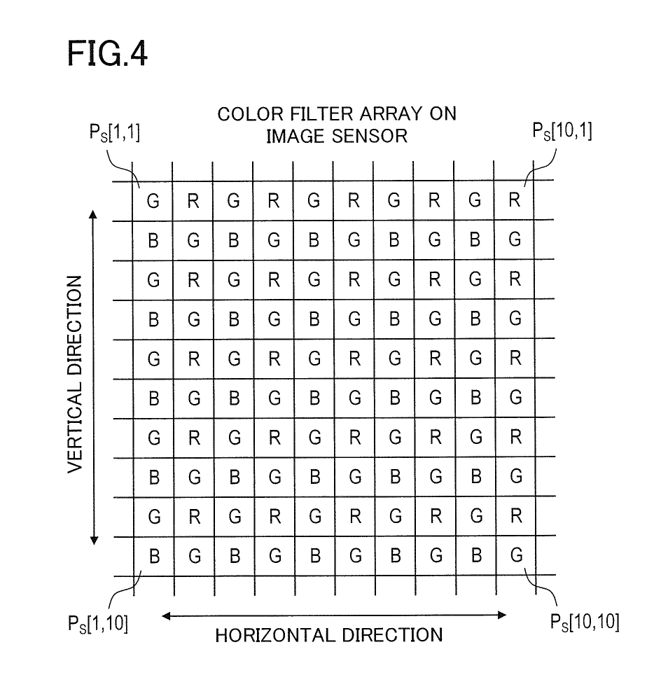

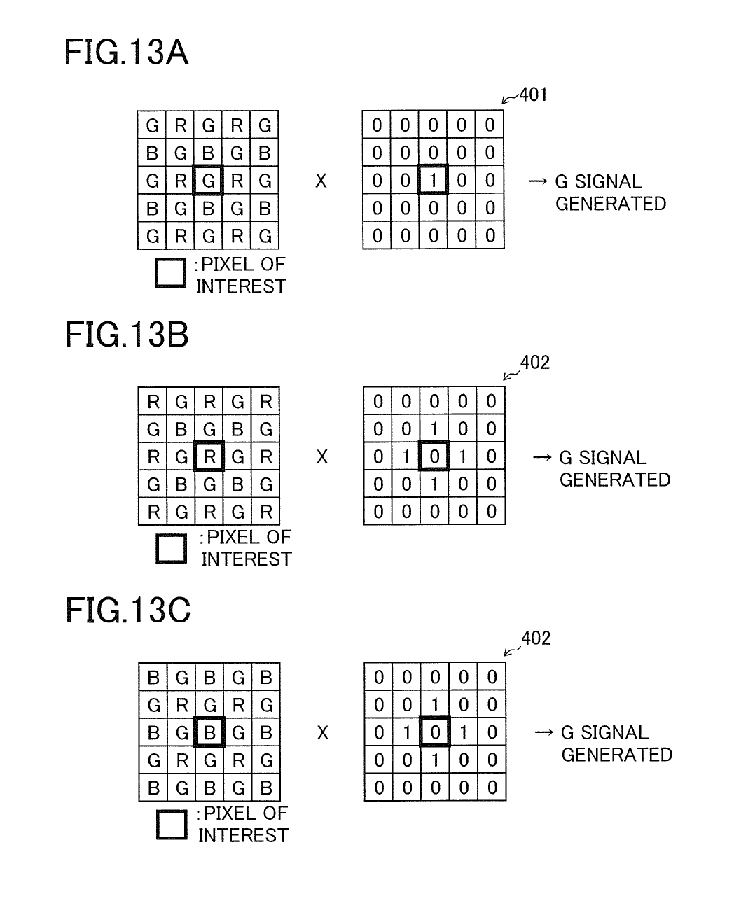

The image-shooting device 1 uses only one image sensor, thus adopting a so-called single-panel design. That is, the image sensor 33 is a single-panel image sensor. FIG. 4 shows an array of color filters arranged one in front of each photoreceptive pixel of the image sensor 33. The array shown in FIG. 4 is generally called a Bayer array. The color filters include red filters that transmit only the red component of light, green filters that transmit only the green component of light, and blue filters that transmit only the blue component of light. Red filters are arranged in front of photoreceptive pixels P_{S}[2n_{A}, 2n_{B}−1], blue filters are arranged in front of photoreceptive pixels P_{S}[2n_{A}−1, 2n_{B}], and green filters are arranged in front of photoreceptive pixels P_{S}[2n_{A}−1, 2n_{B}−1] and P_{S}[2n_{A}, 2n_{B}]. Here, n_{A} and n_{B} are integers. In FIG. 4, and also in FIG. 13A etc., which will be mentioned later, parts corresponding to red filters are indicated by “R,” parts corresponding to green filters are indicated by “G,” and parts corresponding to blue filters are indicated by “B.”

Photoreceptive pixels having red, green, and blue filters arranged in front of them are also referred to as red, green, and blue photoreceptive pixels respectively. Red, green, and blue photoreceptive pixels react only to the red, green, and blue components, respectively, of the light incoming through the optical system. Each photoreceptive pixel photoelectrically converts the light incident on it through the color filter arranged in front of itself into an electrical signal, and outputs the thus obtained electrical signal as a photoreceptive pixel signal.

Photoreceptive pixel signals are amplified and also digitized by the AFE 12, and the amplified and digitized photoreceptive pixel signals are output as RAW data from the AFE 12. In the following description, however, for the sake of simple explanation, signal digitization and signal amplification in the AFE 12 are disregarded, and the photoreceptive pixel signals themselves that are output from photoreceptive pixels are also referred to as RAW data.

FIG. 5 shows how an extraction frame EF is set within the effective pixel region 33_{A} of the image sensor 33. It is here assumed that the extraction frame EF is a rectangular frame, that the aspect ratio of the extraction frame EF is equal to the aspect ratio of the effective pixel region 33_{A}, and that the center position of the extraction frame EF coincides with the center position of the effective pixel region 33_{A}. The two-dimensional image formed by the photoreceptive pixel signals within the extraction frame EF, that is, the two-dimensional image that has as its image data the RAW data within the extraction frame EF, is referred to as the RAW image. The RAW image may be called the extraction image. For the sake of concrete and simple explanation, it is assumed that the aspect ratio of any image mentioned in the embodiment under discussion is equal to the aspect ratio of the extraction frame EF. The region within the extraction frame EF may be called the extraction region (or the extraction target region). Thus, in the embodiment under discussion, extraction frame can be read as extraction region (or extraction target region), and extraction frame setting section, which will be described later, may be read as extraction region setting section or extraction target region setting section. Setting, changing, or otherwise handling the extraction frame is synonymous with setting, changing, or otherwise handling the extraction region, and setting, changing, or otherwise handling the size of the extraction frame is synonymous with setting, changing, or otherwise handling the size of the extraction region.

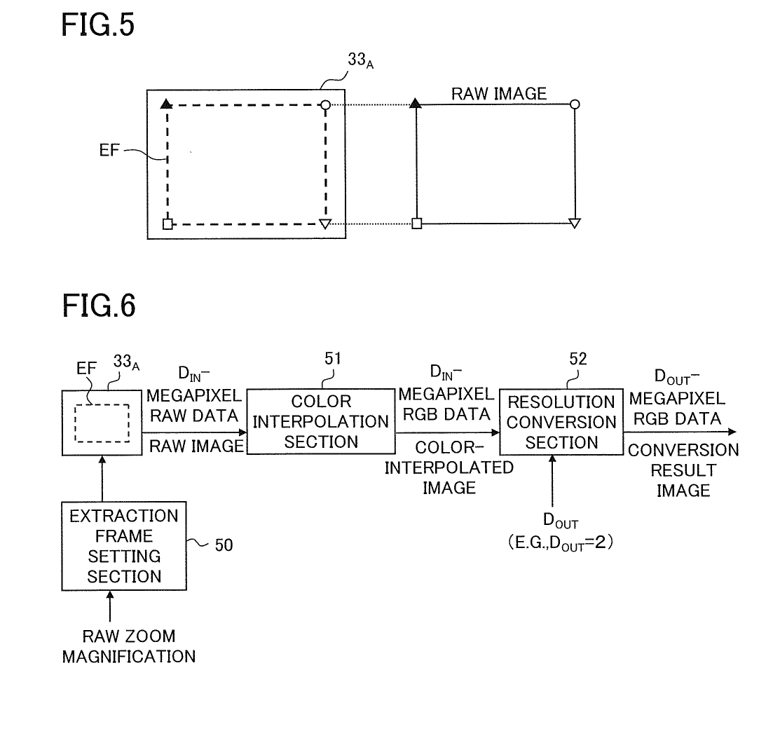

In the embodiment under discussion, a concept is introduced of RAW zooming that allows change of image size through change of the size of the extraction frame EF. The factor by which image size is changed by RAW zooming is referred to as the RAW zoom magnification. FIG. 6 is a diagram of blocks involved in RAW zooming. For example, an extraction frame setting section 50 can be realized by the CPU 23 in FIG. 1, and a color interpolation section 51 and a resolution conversion section 52 can be provided in the video signal processing section 13 in FIG. 1.

A RAW zoom magnification is fed into the extraction frame setting section 50. As will be described in detail later, the RAW zoom magnification is set according to a user operation. A user operation denotes an operation performed on the operation section 26 by the user. According to the RAW zoom magnification, the extraction frame setting section 50 sets the size of the extraction frame EF. The number of photoreceptive pixels belonging to the extraction frame EF is expressed as (D_{IN}×1,000,000) (where D_{IN} is a positive real number). The extraction frame setting section 50 serves also as a reading control section, reading out RAW data worth D_{IN} megapixels from photoreceptive pixels worth D_{IN} megapixels that belong to the extraction frame EF. The D_{IN}-megapixels-worth RAW data thus read out is fed to the color interpolation section 51. In other words, a RAW image having D_{IN}-megapixels-worth RAW data as image data is fed to the color interpolation section 51.

A single piece of RAW data is a color signal of one of red, green, and blue. Accordingly, in a two-dimensional image represented by RAW data, red color signals are arranged in a mosaic pattern according to the color filter array (the same applies to green and blue). The color interpolation section 51 performs color interpolation (color interpolation processing) on the D_{IN}-megapixels-worth RAW data to generate color-interpolated image composed of D_{IN} megapixels (in other words, a color interpolation image having a D_{IN}-megapixel image size). Well-known demosaicing processing can be used as color interpolation processing. The pixels of the color-interpolated image are each assigned R, G, and B signals as mutually different color signals, or luminance signal Y and color difference signals U and V. In the following description, it is assumed that, through color interpolation processing, R, G, and B signals are generated from RAW data, and image data expressed by R, G, and B signals is referred to as RGB data. Then, the color-interpolated image generated by the color interpolation section 51 has RGB data worth D_{IN} megapixels. D_{IN}-megapixels-worth RGB data is composed of D_{IN}-megapixels-worth R signals, D_{IN}-megapixels-worth G signals, and D_{IN}-megapixels-worth B signals (the same applies to D_{OUT}-megapixels-worth RGB data or YUV data, which will be discussed later).

The resolution conversion section 52 performs resolution conversion to convert the image size of the color-interpolated image from D_{IN} megapixels to D_{OUT} megapixels, and thereby generates, as a conversion result image, a color-interpolated image having undergone the resolution conversion (that is, a color-interpolated image having a D_{OUT}-megapixel image size). The resolution conversion is achieved by well-known resampling. The conversion result image generated by the resolution conversion section 52 is composed of D_{OUT} megapixels of pixels, and has RGB data worth D_{OUT} megapixels. D_{OUT} is a positive real number, and fulfills D_{IN}≧D_{OUT}. When D_{IN}=D_{OUT}, the conversion result image generated by the resolution conversion section 52 is identical with the color-interpolated image generated by the color interpolation section 51.

The value of D_{OUT} is fed into the resolution conversion section 52. The user can specify the value of D_{OUT} through a predetermined operation on the operation section 26. Instead, the value of D_{OUT} may be constant. In the following description, unless otherwise indicated, it is assumed that D_{OUT}=2. Then, D_{IN} is 2 or more but 8 or less (because, as mentioned above, it is assumed that M_{H}=4,000 and M_{V}=2,000; see FIG. 3B).

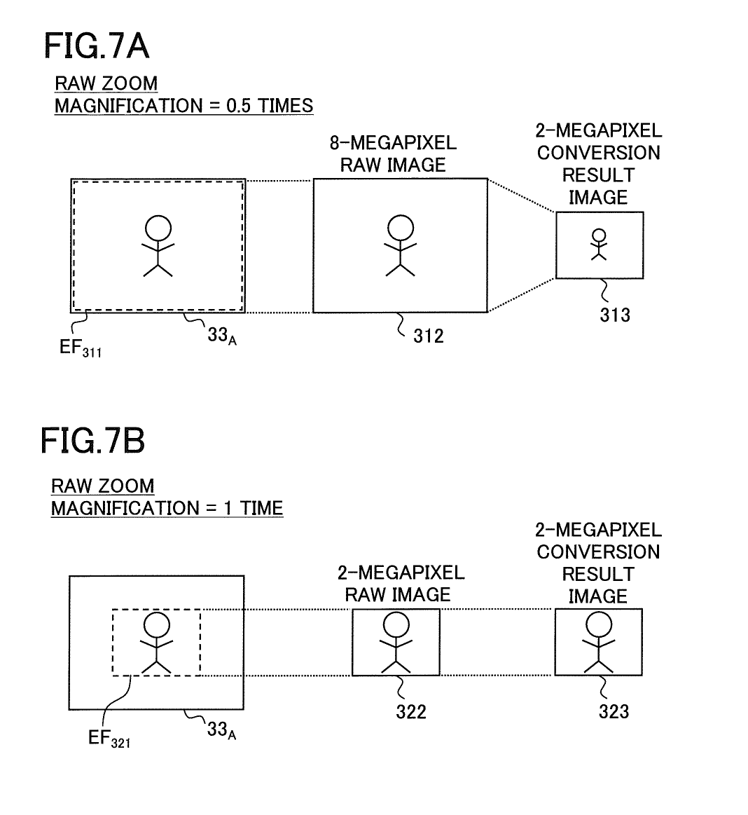

Now, with reference to FIGS. 7A and 7B, the relationship between the RAW zoom magnification and the extraction frame EF and related features will be described. In FIGS. 7A and 7B, the broken-line rectangular frames EF₃₁₁ and EF₃₂₁ represent the extraction frame EF when the RAW zoom magnification is 0.5 times and 1.0 time respectively. FIG. 7A shows a RAW image 312 and a conversion result image 313 when the RAW zoom magnification is 0.5 times, and FIG. 7B shows a RAW image 322 and a conversion result image 323 when the RAW zoom magnification is 1 time.

The extraction frame setting section 50 determines the image size (dimensions) of the extraction frame EF from the RAW zoom magnification according to the following definition formula:

$$\begin{matrix}( RAW Zoom Magnification ) = \begin{matrix}√ ( ( Image Size of Conversion \\ Result Image ) /\end{matrix} \\ ( Image Size of Extraction Frame EF ) ) \\ = √ ( ( {D}_{OUT} Megapixels ) / ( {D}_{IN} Megapixels ) ) \\ = √ ( {D}_{OUT} / {D}_{IN} ) .\end{matrix}$$

That is, the extraction frame setting section 50 determines the size of the extraction frame EF (in other words the image size of the extraction frame EF) such that the positive square root of (D_{OUT}/D_{IN}) equals (or approximately equals) the RAW zoom magnification. In the embodiment under discussion, since it is assumed that D_{OUT}=2, the variable range of the RAW zoom magnification is between 0.5 times and 1 time.

When the RAW zoom magnification is 0.5 times, the definition formula above dictates that the image size of the extraction frame EF is 8 megapixels; thus, as shown in FIG. 7A, an extraction frame EF₃₁₁ of the same size as the effective pixel region 33_{A} is set, with the result that a RAW image 312 having an 8-megapixel image size is read out. In this case, the resolution conversion section 52 reduces a color-interpolated image (not shown) based on the RAW image 312 and having an 8-megapixel image size to one-half (½) both in the horizontal and vertical directions, and thereby generates a conversion result image 313 having a 2-megapixel image size. In FIG. 7A, for the sake of convenience of illustration, the extraction frame EF₃₁₁ is shown to appear somewhat smaller than the outer frame of the effective pixel region 33_{A}.

When the RAW zoom magnification is 1 time, the definition formula above dictates that the image size of the extraction frame EF is 2 megapixels; thus, as shown in FIG. 7B, an extraction frame EF₃₂₁ having a 2-megapixel image size is set within the effective pixel region 33_{A}, with the result that a RAW image 322 having an 2-megapixel image size is read out. In this case, a resolution conversion section 72 outputs as the conversion result image 323 a color-interpolated image (not shown) based on the RAW image 322 and having a 2-megapixel image size.

As will be understood from the definition formula above and FIGS. 7A and 7B, as the RAW zoom magnification increases, the extraction frame EF becomes increasingly small, and the angle of view of the conversion result image becomes increasingly small. Thus, by increasing the RAW zoom magnification, it is possible to obtain an effect of virtually increasing the optical zoom magnification without degradation in image quality. The angle of view of the conversion result image is a representation, in the form of an angle, of the range of shooting space expressed by the conversion result image (a similar description applies to the angle of view of any image other than a conversion result image and to the angle of view of the image formed on the effective pixel region 33_{A}).

Reducing the image size by resolution conversion based on the RAW zoom magnification accordingly alleviates the calculation load in signal processing (such as YUV conversion and signal compression) in later stages. Thus, during the shooting and recording of moving images, when temporal constraints in signal processing are comparatively strict, the use of RAW zooming is particularly beneficial.

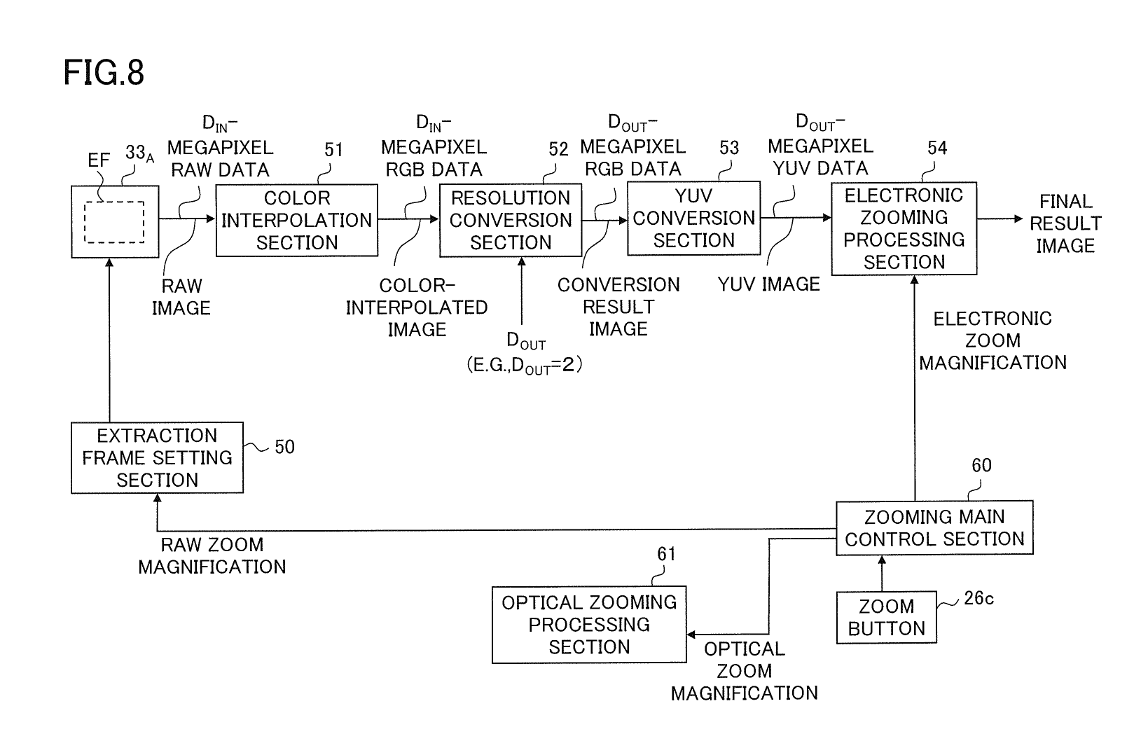

The image-shooting device 1 is capable of, in addition to RAW zooming mentioned above, optical zooming and electronic zooming. FIG. 8 is a block diagram of the blocks particularly involved in the angle-of-view adjustment of an image to be acquired by shooting. All the blocks shown in FIG. 8 may be provided in the image-shooting device 1. A zooming main control section 60 is realized, for example, by the CPU 23. An optical zooming processing section 61 is realized by, for example, the driver 34 and the zoom lens 30 in FIG. 2. A YUV conversion section 53 and an electronic zooming processing section 54 are provided, for example, within the video signal processing section 13 in FIG. 1.

An operation of the zoom button 26c by the user is referred to as a zoom operation. According to a zoom operation, the zooming main control section 60 determines an overall zoom magnification and, from the overall zoom magnification, determines an optical zoom magnification, a RAW zoom magnification, and an electronic zoom magnification. According to the RAW zoom magnification set by the zooming main control section 60, the extraction frame setting section 50 sets the size of the extraction frame EF.

The optical zooming processing section 61 controls the position of the zoom lens 30 such that the angle of view of the image formed on the effective pixel region 33_{A} is commensurate with the optical zoom magnification set by the zooming main control section 60. That is, the optical zooming processing section 61 controls the position of the zoom lens 30 according to the optical zoom magnification, and thereby sets the angle of view of the image formed on the effective pixel region 33_{A} of the image sensor 33. As the optical zoom magnification increases to k_{C} times from a given magnification, the angle of view of the image formed on the effective pixel region 33_{A} diminishes to 1/k_{C} times both in the horizontal and vertical directions of the image sensor 33 (where k_{C} is a positive number, for example 2).

The YUV conversion section 53 converts, through YUV conversion, the data format of the image data of the conversion result image obtained at the resolution conversion section 52 into a YUV format, and thereby generates a YUV image. Specifically, the YUV conversion section 53 converts the R, G, and B signals of the conversion result image into luminance signals Y and color difference signals U and V, and thereby generates a YUV image composed of the luminance signal Y and color difference signals U and V thus obtained. Image data expressed by luminance signals Y and color difference signals U and V is also referred to as YUV data. Then, the YUV image generated at the YUV conversion section 53 has YUV data worth D_{OUT} megapixels.

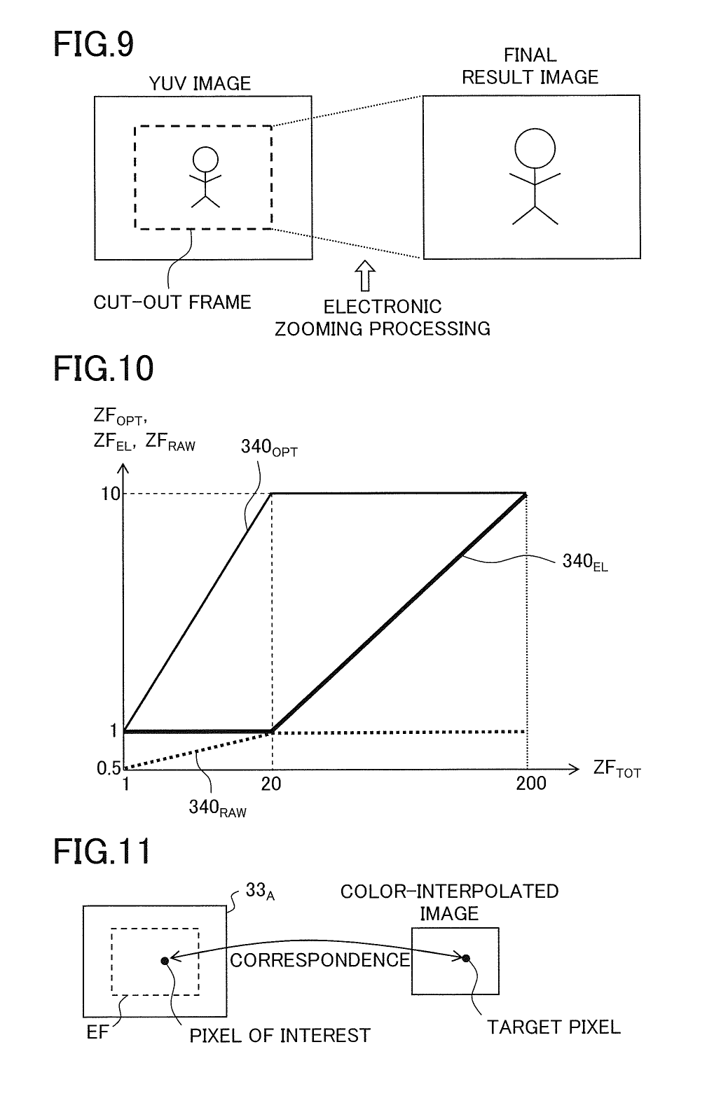

The electronic zooming processing section 54 applies electronic zooming processing according to the electronic zoom magnification set at the zooming main control section 60 to the YUV image, and thereby generates a final result image. Electronic zooming processing denotes processing whereby, as shown in FIG. 9, a cut-out frame having a size commensurate with the electronic zoom magnification is set within the image region of the YUV image and the image obtained by applying image size enlargement processing to the image (hereinafter referred to as the cut-out image) within the cut-out frame on the YUV image is generated as a final result image. When the electronic zoom magnification is 1 time, the image size of the cut-out frame is equal to the image size of the YUV image (thus, the final result image is identical with the YUV image), and as the electronic zoom magnification increases, the image size of the cut-out frame decreases. The image size of the final result image can be made equal to the image size of the YUV image. The image data of the final result image can be displayed on the display section 27, and can also be recorded to the external memory 18.

The overall zoom magnification, the optical zoom magnification, the electronic zoom magnification, and the RAW zoom magnification are represented by the symbols ZF_{TOT}, ZF_{OPT}, ZF_{EL}, and ZF_{RAW} respectively. Then, the formula

ZF_{TOT}=ZF_{OPT}×ZF_{EL}×ZF_{RAW}×2

holds. Accordingly, the angle of view of the final result image decreases as the overall zoom magnification increases.

In the embodiment under discussion, it is assumed that the variable ranges of the optical zoom magnification and the electronic zoom magnification are each between 1 time and 10 times. Then, the variable range of the overall zoom magnification is between 1 time and 200 times. FIG. 10 shows an example of the relationship among the magnifications ZF_{TOT}, ZF_{OPT}, ZF_{EL}, and ZF_{RAW}. The solid bent line 340_{OPT} represents the relationship between ZF_{TOT} and ZF_{OPT}, the solid bent line 340_{EL} represents the relationship between ZF_{TOT} and ZF_{EL}, and the broken bent line 340_{RAW} represents the relationship between ZF_{TOT} and ZF_{RAW}.

In the range fulfilling 1≦ZF_{TOT}≦20, while the magnification ZF_{EL} is kept constant at 1 time, as the magnification ZF_{TOT} increases from 1 time to 20 times, the magnification ZF_{OPT} increases from 1 time to 10 times and also the magnification ZF_{RAW} increases from 0.5 times to 1 times.

In the range fulfilling 20≦ZF_{TOT}≦200, while the magnification ZF_{OPT} is kept constant at 10 times and also the magnification ZF_{RAW} is kept constant at 1 time, as the magnification ZF_{TOT} increases from 20 times to 200 times, the magnification ZF_{EL} increases from 1 time to 10 times.

In the range fulfilling 1≦ZF_{TOT}≦20, as the magnification ZF_{TOT} varies, the magnification ZF_{RAW} varies together, and as the magnification ZF_{RAW} varies, the size of the extraction frame EF (hence, the number of photoreceptive pixels inside the extraction frame EF) varies together.

Next, color interpolation processing will be described in detail. In color interpolation processing, as shown in FIG. 11, one photoreceptive pixel within the extraction frame EF is taken as a pixel of interest, and the R, G, and B signals of a target pixel corresponding to the pixel of interest are generated. A target pixel is a pixel on a color-interpolated image. By setting the photoreceptive pixels within the extraction frame EF one after another as the pixel of interest, and performing color interpolation processing on each pixel of interest sequentially, the R, G, and B signals for all the pixels of the color-interpolated image are generated. In the following description, unless otherwise stated, a “filter” denotes a spatial filter (spatial domain filter) for use in color interpolation processing.

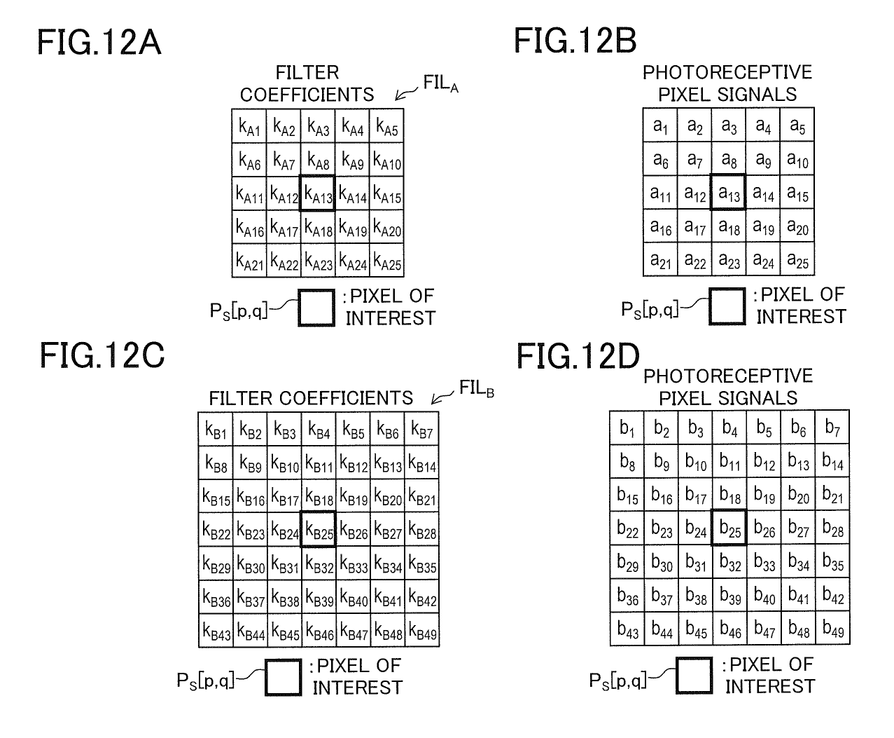

When photoreceptive pixel P_{S}[p, q] is the pixel of interest, color interpolation processing can be performed by use of a filter FIL_{A} shown in FIG. 12A which has a filter size of 5×5. In this case, the value V_{A} obtained according to formula (1) below is the signal value of the target pixel corresponding to photoreceptive pixel P_{S}[p, q]. Here, p and q are natural numbers. The symbols k_{A1} to k_{A25} represent the filter coefficients of the filter FIL_{A}. When photoreceptive pixel P_{S}[p, q] is the pixel of interest, as shown in FIG. 12B, a₁ to a₂₅ are respectively the values (the values of photoreceptive pixel signals) of the following photoreceptive pixels:

$$\begin{matrix}{P}_{S} [ p - 2 , q - 2 ] , {P}_{S} [ p - 1 , q - 2 ] , {P}_{S} [ p , q - 2 ] , {P}_{S} [ p + 1 , q - 2 ] , {P}_{S} [ p + 2 , q - 2 ] , \\ {P}_{S} [ p - 2 , q - 1 ] , {P}_{S} [ p - 1 , q - 1 ] , {P}_{S} [ p , q - 1 ] , {P}_{S} [ p + 1 , q - 1 ] , {P}_{S} [ p + 2 , q - 1 ] , \\ {P}_{S} [ p - 2 , q ] , {P}_{S} [ p - 1 , q ] , {P}_{S} [ p , q ] , {P}_{S} [ p + 1 , q ] , {P}_{S} [ p + 2 , q ] , \\ {P}_{S} [ p - 2 , q + 1 ] , {P}_{S} [ p - 1 , q + 1 ] , {P}_{S} [ p , q + 1 ] , {P}_{S} [ p + 1 , q + 1 ] , {P}_{S} [ p + 2 , q + 1 ] , \\ {P}_{S} [ p - 2 , q + 2 ] , {P}_{S} [ p - 1 , q + 2 ] , {P}_{S} [ p , q + 2 ] , {P}_{S} [ p + 1 , q + 2 ] , {P}_{S} [ p + 2 , q + 2 ] . \\ {V}_{A} = \frac{{\sum }_{i = 1}^{25} ( {k}_{Ai} \times {a}_{i} )}{{\sum }_{i = 1}^{25} {k}_{Ai}}\end{matrix} \qquad ( 1 )$$

Instead, when photoreceptive pixel P_{S}[p, q] is the pixel of interest, color interpolation processing can be performed by use of a filter FIL_{B} shown in FIG. 12C which has a filter size of 7×7. In this case, the value V_{B} obtained according to formula (2) below is the signal value of the target pixel corresponding to photoreceptive pixel P_{S}[p, q]. The symbols k_{B1} to k_{B49} represent the filter coefficients of the filter FIL_{B}. When photoreceptive pixel P_{S}[p, q] is the pixel of interest, as shown in FIG. 12D, b₁ to b₄₉ are respectively the values (the values of photoreceptive pixel signals) of the following photoreceptive pixels:

$$\begin{matrix}{P}_{S} [ p - 3 , q - 3 ] , {P}_{S} [ p - 2 , q - 3 ] , {P}_{S} [ p - 1 , q - 3 ] , {P}_{S} [ p , q - 3 ] , {P}_{S} [ p + 1 , q - 3 ] , {P}_{S} [ p + 2 , q - 3 ] , {P}_{S} [ p + 3 , q - 3 ] , \\ {P}_{S} [ p - 3 , q - 2 ] , {P}_{S} [ p - 2 , q - 2 ] , {P}_{S} [ p - 1 , q - 2 ] , {P}_{S} [ p , q - 2 ] , {P}_{S} [ p + 1 , q - 2 ] , {P}_{S} [ p + 2 , q - 2 ] , {P}_{S} [ p + 3 , q - 2 ] , \\ {P}_{S} [ p - 3 , q - 1 ] , {P}_{S} [ p - 2 , q - 1 ] , {P}_{S} [ p - 1 , q - 1 ] , {P}_{S} [ p , q - 1 ] , {P}_{S} [ p + 1 , q - 1 ] , {P}_{S} [ p + 2 , q - 1 ] , {P}_{S} [ p + 3 , q - 1 ] , \\ {P}_{S} [ p - 3 , q ] , {P}_{S} [ p - 2 , q ] , {P}_{S} [ p - 1 , q ] , {P}_{S} [ p , q ] , {P}_{S} [ p + 1 , q ] , {P}_{S} [ p + 2 , q ] , {P}_{S} [ p + 3 , q ] , \\ {P}_{S} [ p - 3 , q + 1 ] , {P}_{S} [ p - 2 , q + 1 ] , {P}_{S} [ p - 1 , q + 1 ] , {P}_{S} [ p , q + 1 ] , {P}_{S} [ p + 1 , q + 1 ] , {P}_{S} [ p + 2 , q + 1 ] , {P}_{S} [ p + 3 , q + 1 ] , \\ {P}_{S} [ p - 3 , q + 2 ] , {P}_{S} [ p - 2 , q + 2 ] , {P}_{S} [ p - 1 , q + 2 ] , {P}_{S} [ p , q + 2 ] , {P}_{S} [ p + 1 , q + 2 ] , {P}_{S} [ p + 2 , q + 2 ] , {P}_{S} [ p + 3 , q + 2 ] , \\ {P}_{S} [ p - 3 , q + 3 ] , {P}_{S} [ p - 2 , q + 3 ] , {P}_{S} [ p - 1 , q + 3 ] , {P}_{S} [ p , q + 3 ] , {P}_{S} [ p + 1 , q + 3 ] , {P}_{S} [ p + 2 , q + 3 ] , {P}_{S} [ p + 3 , q + 3 ] . \\ {V}_{B} = \frac{{\sum }_{i = 1}^{49} ( {k}_{Bi} \times {b}_{i} )}{{\sum }_{i = 1}^{49} {k}_{Bi}}\end{matrix} \qquad ( 2 )$$

The color interpolation section 51 extracts the photoreceptive pixel signals of green photoreceptive pixels within a predetermined region centered around the pixel of interest, and mixes the extracted photoreceptive pixel signals to generate the G signal of the target pixel (in a case where only one photoreceptive pixel signal is extracted, the extracted photoreceptive pixel signal itself may be used as the G signal of the target pixel).

Similarly, the color interpolation section 51 extracts the photoreceptive pixel signals of red photoreceptive pixels within a predetermined region centered around the pixel of interest, and mixes the extracted photoreceptive pixel signals to generate the R signal of the target pixel (in a case where only one photoreceptive pixel signal is extracted, the extracted photoreceptive pixel signal itself may be used as the R signal of the target pixel).

Similarly, the color interpolation section 51 extracts the photoreceptive pixel signals of blue photoreceptive pixels within a predetermined region centered around the pixel of interest, and mixes the extracted photoreceptive pixel signals to generate the B signal of the target pixel (in a case where only one photoreceptive pixel signal is extracted, the extracted photoreceptive pixel signal itself may be used as the B signal of the target pixel).

### Basic Color Interpolation Processing

FIGS. 13A to 13C, 14A to 14D, and 15A to 15D show the content of basic color interpolation processing.

To generate a G signal through basic color interpolation processing, the color interpolation section 51,

if, as shown in FIG. 13A, the pixel of interest is a green photoreceptive pixel, generates the G signal of the target pixel by use of a filter 401, and,

if, as shown in FIG. 13B or 13C, the pixel of interest is a red or blue photoreceptive pixel, generates the G signal of the target pixel by use of a filter 402.

To generate an R signal through basic color interpolation processing, the color interpolation section 51,

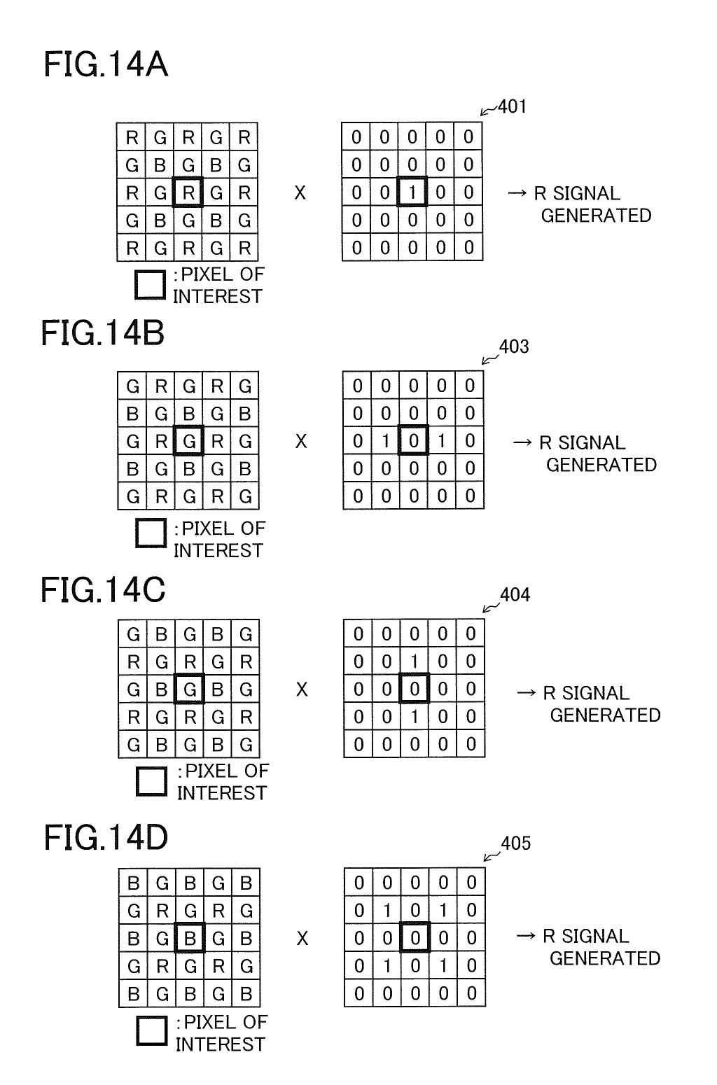

if, as shown in FIG. 14A, the pixel of interest is a red photoreceptive pixel, generates the R signal of the target pixel by use of the filter 401,

if, as shown in FIG. 14B, the pixel of interest is a green photoreceptive pixel P_{S}[2n_{A}−1, 2n_{B}−1], generates the R signal of the target pixel by use of a filter 403,

if, as shown in FIG. 14C, the pixel of interest is a green photoreceptive pixel P_{S}[2n_{A}, 2n_{B}], generates the R signal of the target pixel by use of a filter 404, and,

if, as shown in FIG. 14D, the pixel of interest is a blue photoreceptive pixel, generates the R signal of the target pixel by use of a filter 405.

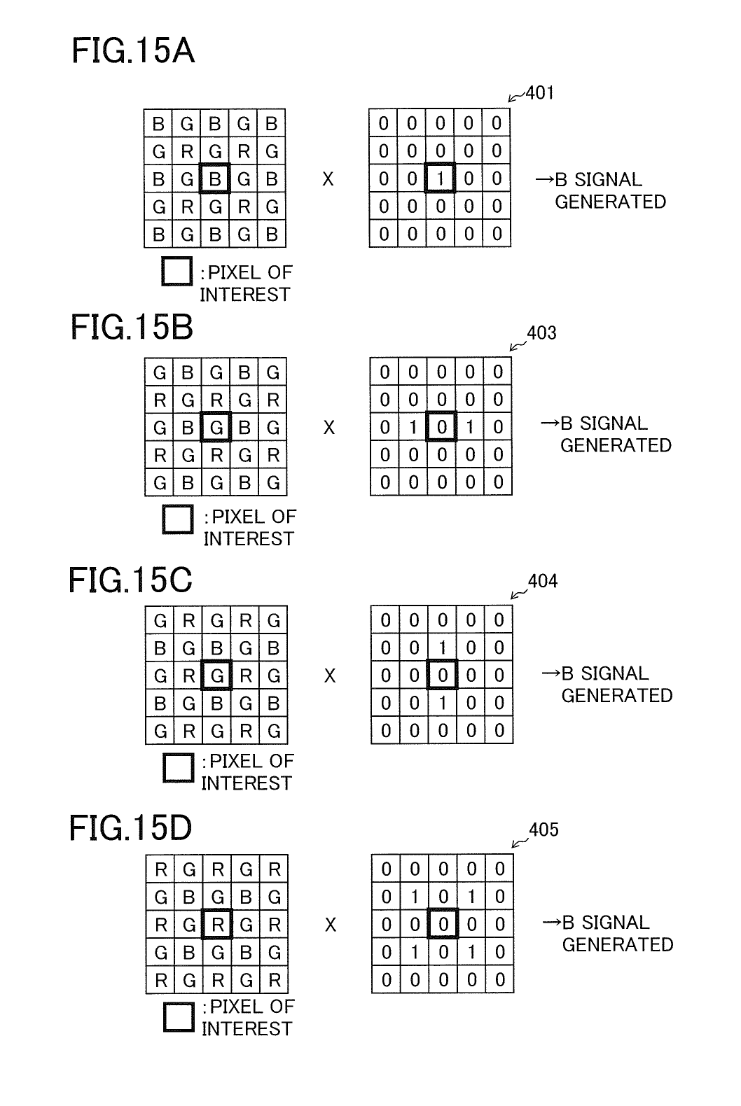

As shown in FIGS. 15A to 15D, the filters used to generate a B signal through basic color interpolation processing are similar to those used to generate an R signal through basic color interpolation processing. This applies also to color interpolation processing in a first to a fourth practical example described later. It should however be noted that the filter used when the pixel of interest is a red photoreceptive pixel and the filter used when the pixel of interest is a blue photoreceptive pixel are reversed between for generation of an R signal and for generation of a B signal, and that the filter used when the pixel of interest is a green photoreceptive pixel P_{S}[2n_{A}−1, 2n_{B}−1] and the filter used when the pixel of interest is a green photoreceptive pixel P_{S}[2n_{A}, 2n_{B}] are reversed between for generation of an R signal and for generation of a B signal (the same applies also to color interpolation processing in the first to fourth practical examples described later).

The filters 401 to 405 are each an example of the filter FIL_{A}.

Of the filter coefficients k_{A1} to k_{A25} of the filter 401, only k_{A13} is 1, and all the rest are 0.

Of the filter coefficients k_{A1} to k_{A25} of the filter 402, only k_{A8}, k_{A12}, k_{A14} and k_{A18} are 1, and all the rest are 0.

Of the filter coefficients k_{A1} to k_{A25} of the filter 403, only k_{A12} and k_{A14} are 1, and all the rest are 0.

Of the filter coefficients k_{A1} to k_{A25} of the filter 404, only k_{A8} and k_{A18} are 1, and all the rest are 0.

Of the filter coefficients k_{A1} to k_{A25} of the filter 405, only k_{A7}, k_{A9}, k_{A17}, and k_{A19} are 1, and all the rest are 0.

When a G signal is generated through basic color interpolation processing with the pixel of interest being a green photoreceptive pixel as show in FIG. 13A (that is, when a G signal of the target pixel corresponding to a green photoreceptive pixel is generated through basic color interpolation processing), the spatial frequency characteristic with respect to that G signal does not change between before and after the color interpolation processing. On the other hand, the maximum spatial frequency that can be expressed in the conversion result image 313 (see FIG. 7A) generated when the RAW zoom magnification is 0.5 times is smaller than that in the RAW image 312. Accordingly, if, for the sake of discussion, the G signal of the target pixel corresponding to a green photoreceptive pixel is generated through basic color interpolation processing when the RAW zoom magnification is 0.5 times, high spatial frequency components that cannot be expressed in the 2-megapixel conversion result image 313 may mix with the conversion result image 313, causing aliasing in the conversion result image 313. Aliasing appears, for example, as so-called false color or noise. Thus, in a case where the RAW zoom magnification is comparatively low (for example, 0.5 times), when a G signal of the target pixel corresponding to a green photoreceptive pixel is generated, it is preferable that color interpolation processing include a smoothing function.

In contrast, the filter 402 in FIG. 13B has a smoothing function; thus, when a G signal is generated through basic color interpolation processing with the pixel of interest being a red photoreceptive pixel as shown in FIG. 13B (that is, when a G signal of the target pixel corresponding to a red photoreceptive pixel is generated through basic color interpolation processing), the high-frequency spatial frequency components that are contained in the RAW image are attenuated by the basic color interpolation processing. On the other hand, the maximum spatial frequency that can be expressed in the conversion result image 323 (see FIG. 7B) generated when the RAW zoom magnification is 1 time is equal to that of the RAW image 322. Accordingly, if, for the sake of discussion, a G signal of the target pixel corresponding to a red photoreceptive pixel is generated through basic color interpolation processing when the RAW zoom magnification is 1 time, the smoothing function of the filter 402 may result in lack in resolution (resolving power) in the conversion result image 323. Therefore, in a case where the RAW zoom magnification is comparatively high (for example, 1 time), when a G signal of the target pixel corresponding to a red photoreceptive pixel is generated through color interpolation processing, it is preferable that the color interpolation processing include a function of emphasizing or restoring the high-frequency components of the G signal.

The same applies also when a G signal of the target pixel corresponding to a blue photoreceptive pixel is generated. A description similar to that given above may apply when the R and B signals of the target pixel are generated.

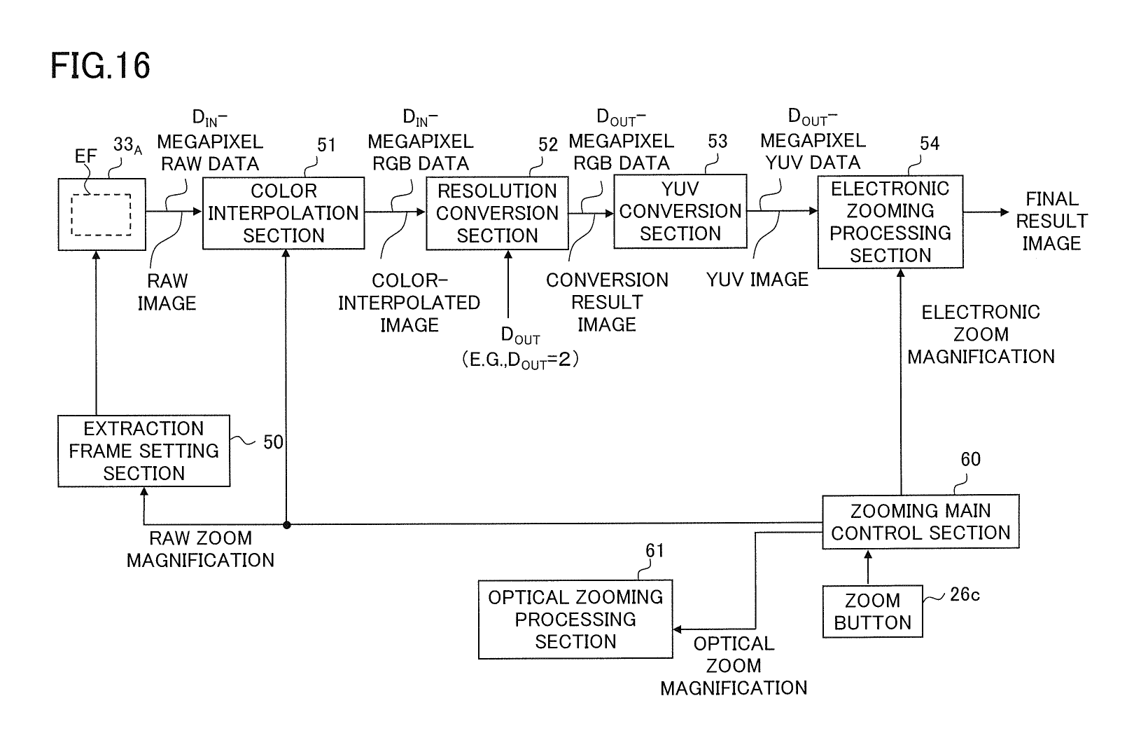

In view of the foregoing, as shown in FIG. 16, the color interpolation section 51 controls the content of the filters used in color interpolation processing according to the RAW zoom magnification, and thereby controls the spatial frequency characteristic of the image having undergone the color interpolation processing. The color-interpolated image, the conversion result image, the YUV image, and the final result image are all images having undergone color interpolation processing of which the spatial frequency characteristic is to be controlled by the color interpolation section 51. In the following description, for the sake of concreteness, a method of controlling the spatial frequency characteristic will be described with attention paid mainly to the conversion result image; it should however be noted that controlling and changing the spatial frequency characteristic in the conversion result image amounts to controlling and changing the spatial frequency characteristic in the color-interpolated image, the YUV image, or the final result image.

The color interpolation section 51 (and the resolution conversion section 52) can control the spatial frequency characteristic of the conversion result image according to the ratio D_{OUT}/D_{IN} of D_{OUT} megapixels, which represents the number of pixels of the conversion result image, to D_{IN} megapixels, which represents the number of photoreceptive pixels within the extraction frame EF (that is, the number of photoreceptive pixels belonging to the extraction frame EF). Here, the color interpolation section 51 (and the resolution conversion section 52) can change the spatial frequency characteristic of the conversion result image by changing the content of the color interpolation processing (the content of the filters used in the color interpolation processing) according to variation in the ratio D_{OUT}/D_{IN}. Since variation in the RAW zoom magnification causes the ratio D_{OUT}/D_{IN} to vary, the color interpolation section 51 (and the resolution conversion section 52) may be said to change the spatial frequency characteristic of the conversion result image in a manner interlocked with variation in the RAW zoom magnification or the overall zoom magnification.

In the following description, for the sake of simple reference, the control of the spatial frequency characteristic of the conversion result image is referred to simply as frequency characteristic control. Frequency characteristic control amounts to the control of the spatial frequency characteristic of the color-interpolated image, the YUV image, or the final result image. As specific methods of frequency characteristic control, or as specific examples of related methods, four practical examples will be presented below. Unless inconsistent, two or more of those practical examples may be combined, and any feature of one practical example may be applied to any other.

### Example 1

A first practical example (Example 1) of frequency characteristic control through color interpolation processing will now be described. Whereas in some later-described practical examples, it is assumed that the RAW image contains blur ascribable to camera shake or the like, in Example 1, and also in Example 2, which will be described next, it is assumed that the RAW image contains no blur.

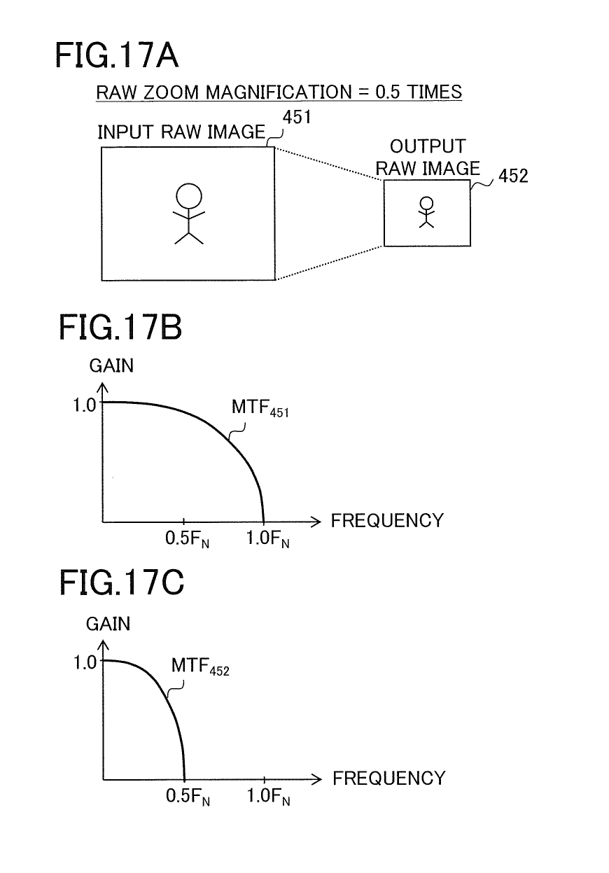

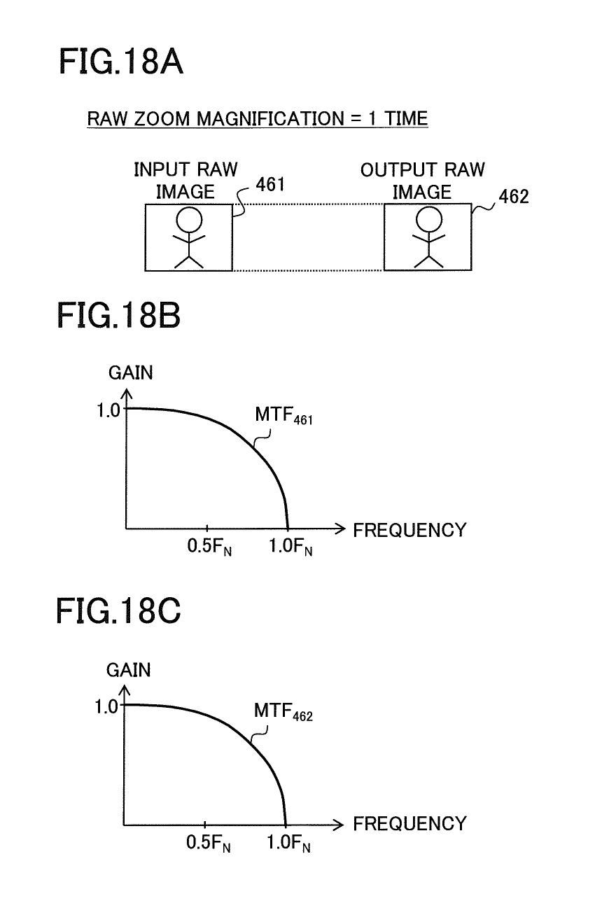

Consider an input RAW image 451 and an output RAW image 452 shown in FIG. 17A and an input RAW image 461 and an output RAW image 462 shown in FIG. 18A. The input RAW images 451 and 461 are examples of the RAW image. The output RAW image 452 is an image obtained by applying resolution conversion by the resolution conversion section 52 to the input RAW image 451 under the condition ZF_{RAW}=0.5. That is, the output RAW image 452 is a RAW image obtained by reducing the image size of the input RAW image 451 to one-half both in the horizontal and vertical directions. The output RAW image 462 is an image obtained by applying resolution conversion by the resolution conversion section 52 to the input RAW image 461 under the condition ZF_{RAW}=1.0. That is, the output RAW image 462 is identical with the input RAW image 461.

The curves MTF₄₅₁ and MTF₄₅₂ in FIGS. 17B and 17C represent the modulation transfer functions (MTFs) of the input RAW image 451 and the output RAW image 452 respectively. The curves MTF₄₆₁ and MTF₄₆₂ in FIGS. 18B and 18C represent the modulation transfer functions (MTFs) of the input RAW image 461 and the output RAW image 462 respectively. The symbol F_{N} represents the Nyquist frequency of the input RAW images 451 and 461.

When ZF_{RAW}=0.5, the number of pixels of the output RAW image equals one-half of that of the input RAW image both in the vertical and horizontal directions. Therefore, the Nyquist frequency of the output RAW image 452 equals 0.5 F_{N}. That is, the maximum spatial frequency that can be expressed in the output RAW image 452 equals one-half of the maximum spatial frequency that can be expressed in the input RAW image 451.

On the other hand, when ZF_{RAW}=1.0, the number of pixels of the output RAW image equals that of the input RAW image both in the vertical and horizontal directions. Accordingly, the Nyquist frequency of the output RAW image 462 equals 1.0 F_{N}. That is, the maximum spatial frequency that can be expressed in the output RAW image 462 equals the maximum spatial frequency that can be expressed in the input RAW image 461.

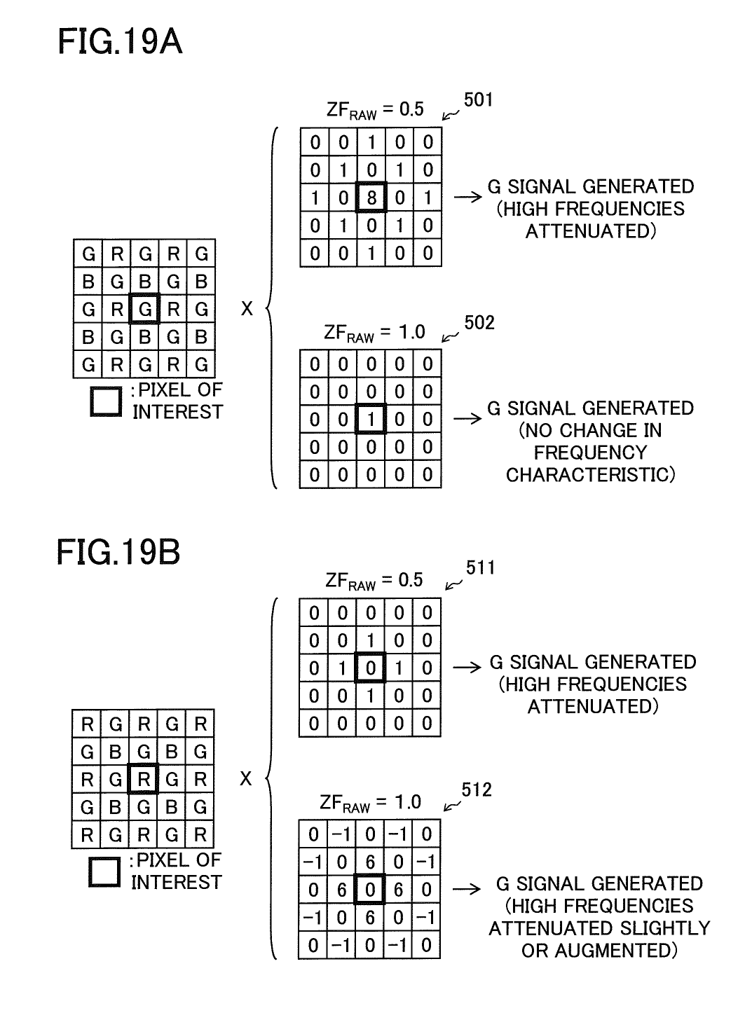

With consideration given to the above-discussed difference in frequency characteristic according to the RAW zoom magnification ZF_{RAW}, in the color interpolation processing in Example 1, to suppress aliasing as well as lack in resolution (resolving power), filters as shown in FIGS. 19A and 19B are used in color interpolation processing.

Specifically, when a G signal is generated under the condition ZF_{RAW}=0.5, the color interpolation section 51,

if, as shown in FIG. 19A, the pixel of interest is a green photoreceptive pixel, generates the G signal of the target pixel by use of a filter 501, and,

if, as shown in FIG. 19B, the pixel of interest is a red photoreceptive pixel, generates the G signal of the target pixel by use of a filter 511 (the same applies when the pixel of interest is a blue photoreceptive pixel).

On the other hand, when a G signal is generated under the condition ZF_{RAW}=1.0, the color interpolation section 51,

if, as shown in FIG. 19A, the pixel of interest is a green photoreceptive pixel, generates the G signal of the target pixel by use of a filter 502, and,

if, as shown in FIG. 19B, the pixel of interest is a red photoreceptive pixel, generates the G signal of the target pixel by use of a filter 512 (the same applies when the pixel of interest is a blue photoreceptive pixel).

The filters 501, 502, 511, and 512 are each an example of the filter FIL_{A} (see FIG. 12A).

Of the filter coefficients k_{A1} to k_{A25} of the filter 501, k_{A13} is 8, k_{A3}, k_{A7}, k_{A9}, k_{A1l}, k_{A15}, k_{A17}, k_{A19}, and k_{A23} are 1, and all the rest are 0.

The filter coefficients of the filters 502 and 511 are the same as the filter coefficients of the filters 401 and 402, respectively, in FIGS. 13A and 13B.

Of the filter coefficients k_{A1} to k_{A25} of the filter 512, k_{A8}, k_{A12}, k_{A14}, and k_{A18} are 6, k_{A2}, k_{A4}, k_{A6}, k_{A10}, k_{A16}, k_{A20}, k_{A22}, and k_{A24} are −1, and all the rest are 0.

Whereas the filter 501 has a function of smoothing the RAW image, the filter 502 does not have a function of smoothing the RAW image (smoothing of a RAW image is synonymous with smoothing of RAW data or photoreceptive pixel signals). Thus, the intensity of smoothing through color interpolation processing by use of the filter 501 can be said to be higher than the intensity (specifically, 0) of smoothing through color interpolation processing by use of the filter 502. Consequently, whereas when a G signal is generated by use of the filter 501, the high-frequency components of the spatial frequency of the G signal are attenuated, when a G signal is generated by use of the filter 502, no such attenuation occurs.

Whereas the filter 511 has a function of smoothing the RAW image, the filter 512 has a function of enhancing edges in the RAW image (edge enhancement of a RAW image is synonymous with edge enhancement of RAW data or photoreceptive pixel signals). Thus, the intensity of edge enhancement through color interpolation processing by use of the filter 512 can be said to be higher than the intensity (specifically, 0) of edge enhancement through color interpolation processing by use of the filter 511. Consequently, whereas when a G signal is generated by use of the filter 511, the high-frequency components of the spatial frequency of the G signal are attenuated, when a G signal is generated by use of the filter 512, either attenuation of the high-frequency components of the spatial frequency of the G signal does not occur too much or the same components are augmented. Alternatively, the degree of attenuation of the high-frequency components of the spatial frequency of the G signal through color interpolation processing is smaller when the filter 512 is used than when the filter 511 is used.

As described above, by controlling the content of color interpolation processing according to the RAW zoom magnification, the color interpolation section 51 achieves both suppression of aliasing and suppression of lack in resolution (resolving power). It should be noted that the spatial frequency here is the spatial frequency of a G signal. Specifically, when ZF_{RAW}=0.5, the smoothing function of the filters 501 and 511 suppresses aliasing in the conversion result image. On the other hand, when ZF_{RAW}=1.0, using the filters 502 and 512 eliminates or alleviates lack in resolution (resolving power) in the conversion result image.

It is merely as typical examples that filters for cases where ZF_{RAW}=0.5 and ZF_{RAW}=1.0 are discussed above; so long as 0.5≦ZF_{RAW}≦1.0, including when ZF_{RAW}=0.5 and ZF_{RAW}=1.0, advisably, the intensity of smoothing by the filters is increased as ZF_{RAW} decreases, or the intensity of edge enhancement by the filters is increased as ZF_{RAW} increases.

For example, when a G signal is generated under the condition ZF_{RAW}=0.7, the color interpolation section 51,

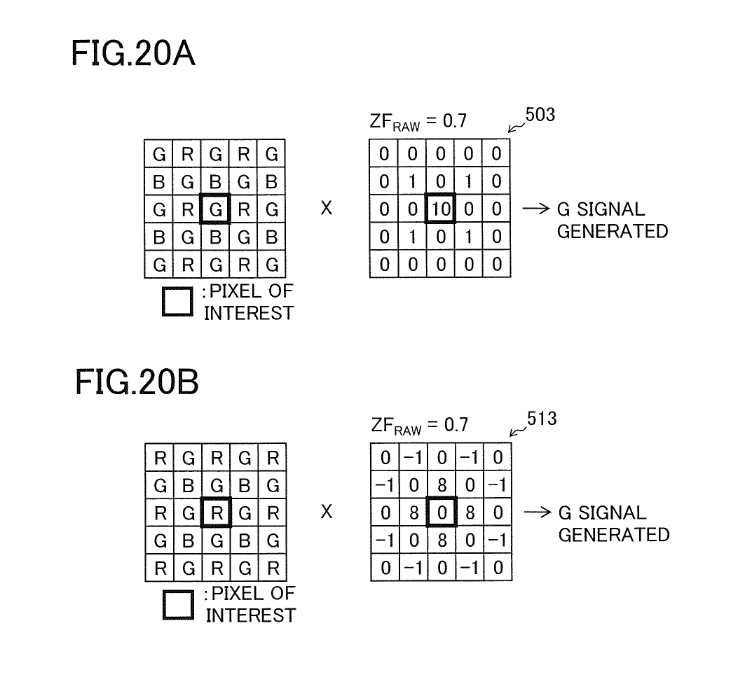

if, as shown in FIG. 20A, the pixel of interest is a green photoreceptive pixel, generates the G signal of the target pixel by use of a filter 503, and,

if, as shown in FIG. 20B, the pixel of interest is a red photoreceptive pixel, generates the G signal of the target pixel by use of a filter 513 (the same applies when the pixel of interest is a blue photoreceptive pixel).

Of the filter coefficients k_{A1} to k_{A25} of the filter 503, k_{A13} is 10, k_{A7}, k_{A9}, k_{A17}, and k_{A19} are 1, and all the rest are 0.

Of the filter coefficients k_{A1} to k_{A25} of the filter 513, k_{A8}, k_{A12}, k_{A14}, and k_{A18} are 8, k_{A2}, k_{A4}, k_{A6}, k_{A10}, k_{A16}, k_{A20}, k_{A22}, and k_{A24} are −1, and all the rest are 0.

The filters 501 and 503 both have a function of smoothing the RAW image, and the intensity of smoothing through color interpolation processing by use of the filter 501 is higher than the intensity of smoothing through color interpolation processing by use of the filter 503. The filters 512 and 513 both have a function of enhancing edges in the RAW image, and the intensity of edge enhancement through color interpolation processing by use of the filter 512 is higher than the intensity of edge enhancement through color interpolation processing by use of the filter 513.

Of R, G, and B signals, G signals are most visually affected by variation in spatial frequency characteristic. Accordingly, frequency characteristic control according to the RAW zoom magnification is applied only to G signals, and basic color interpolation processing is used for R and B signals.

### Example 2

Of course, changing of color interpolation processing according to the RAW zoom magnification may be applied also to the generation of R and B signals. A method of achieving that will now be described as a second practical example (Example 2). While the following description deals only with color interpolation processing with respect to R signals, color interpolation processing with respect to B signals can be performed in a similar manner to that with respect to R signals.

When an R signal is generated under the condition ZF_{RAW}=0.5, the color interpolation section 51,

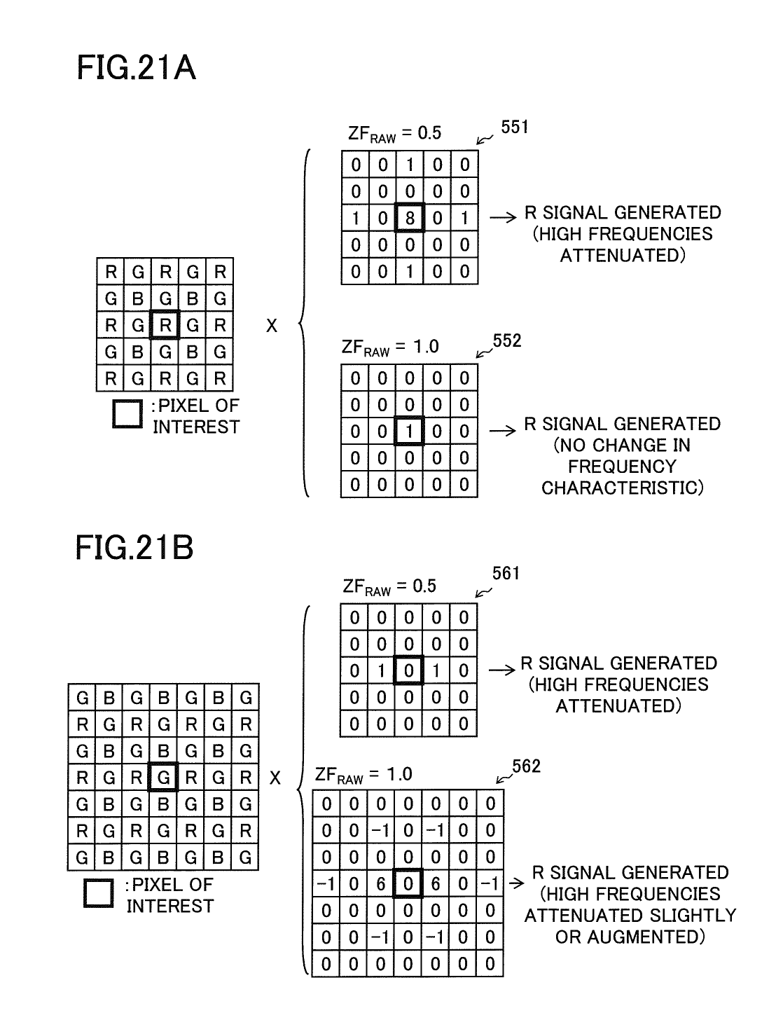

if, as shown in FIG. 21A, the pixel of interest is a red photoreceptive pixel, generates the R signal of the target pixel by use of a filter 551, and,

if, as shown in FIG. 21B, the pixel of interest is a green photoreceptive pixel P_{S}[2n_{A}−1, 2n_{B}−1], generates the R signal of the target pixel by use of a filter 561.

When an R signal is generated under the condition ZF_{RAW}=1.0, the color interpolation section 51,

if, as shown in FIG. 21A, the pixel of interest is a red photoreceptive pixel, generates the R signal of the target pixel by use of a filter 552, and,

if, as shown in FIG. 21B, the pixel of interest is a green photoreceptive pixel P_{S}[2n_{A}−1, 2n_{B}−1], generates the R signal of the target pixel by use of a filter 562.

The filters 551, 552, and 561 are each an example of the filter FIL_{A}, and the filter 562 is an example of the filter FIL_{B} (see FIGS. 12A and 12C).

Of the filter coefficients k_{A1} to k_{A25} of the filter 551, k_{A13} is 8, k_{A3}, k_{A1l}, k_{A15}, and k_{A23} are 1, and all the rest are 0.

The filter coefficients of the filters 552 and 561 are the same as the filter coefficients of the filter 401 and 403, respectively, in FIGS. 14A and 14B.

Of the filter coefficients k_{B1} to k_{B49} of the filter 562, k_{B24} and k_{B26} are 6, k_{B10}, k_{B12}, k_{B22}, k_{B28}, k_{B38}, and k_{B40} are −1, and all the rest are 0.

Whereas the filter 551 has a function of smoothing the RAW image, the filter 552 does not have a function of smoothing the RAW image. Accordingly, the intensity of smoothing through color interpolation processing by use of the filter 551 can be said to be higher than the intensity (specifically, 0) of smoothing through color interpolation processing by use of the filter 552. Consequently, whereas when an R signal is generated by use of the filter 551, the high-frequency components of the spatial frequency of the R signal are attenuated, when an R signal is generated by use of the filter 552, no such attenuation occurs.

Whereas the filter 561 has a function of smoothing the RAW image, the filter 562 has a function of enhancing edges in the RAW image. Thus, the intensity of edge enhancement through color interpolation processing by use of the filter 562 can be said to be higher than the intensity (specifically, 0) of edge enhancement through color interpolation processing by use of the filter 561. Consequently, whereas when an R signal is generated by use of the filter 561, the high-frequency components of the spatial frequency of the R signal are attenuated, when an R signal is generated by use of the filter 562, either attenuation of the high-frequency components of the spatial frequency of the R signal does not occur too much or the same components are augmented. Alternatively, the degree of attenuation of the high-frequency components of the spatial frequency of the R signal through color interpolation processing is smaller when the filter 562 is used than when the filter 561 is used.

As described above, by controlling the content of color interpolation processing according to the RAW zoom magnification, the color interpolation section 51 achieves both suppression of aliasing and suppression of lack in resolution (resolving power). It should be noted that the spatial frequency here is the spatial frequency of an R signal. Specifically, when ZF_{RAW}=0.5, the smoothing function of the filters 551 and 561 suppresses aliasing in the conversion result image. On the other hand, when ZF_{RAW}=1.0, using the filters 552 and 562 eliminates or alleviates lack in resolution (resolving power) in the conversion result image.

It is merely as typical examples that filters for cases where ZF_{RAW}=0.5 and ZF_{RAW}=1.0 are discussed above; so long as 0.5≦ZF_{RAW}≦1.0, including when ZF_{RAW}=0.5 and ZF_{RAW}=1.0, advisably, the intensity of smoothing by the filters is increased as ZF_{RAW} decreases, or the intensity of edge enhancement by the filters is increased as ZF_{RAW} increases. The same applies to the other practical examples described later.

No illustration or description is given of examples of filters used when the pixel of interest is a green photoreceptive pixel P_{S}[2n_{A}, 2n_{B}] or a blue photoreceptive pixel; when the pixel of interest is a green photoreceptive pixel P_{S}[2n_{A}, 2n_{B}] or a blue photoreceptive pixel, on a principle similar to that described above, filters according to the RAW zoom magnification can be used in color interpolation processing.

### Example 3

A third practical example (Example 3) of frequency characteristic control through color interpolation processing will now be described. In Example 3, it is assumed that, during the shooting of the RAW image, the image-shooting device 1 moves, with a result that the RAW image contains degradation due to blur.

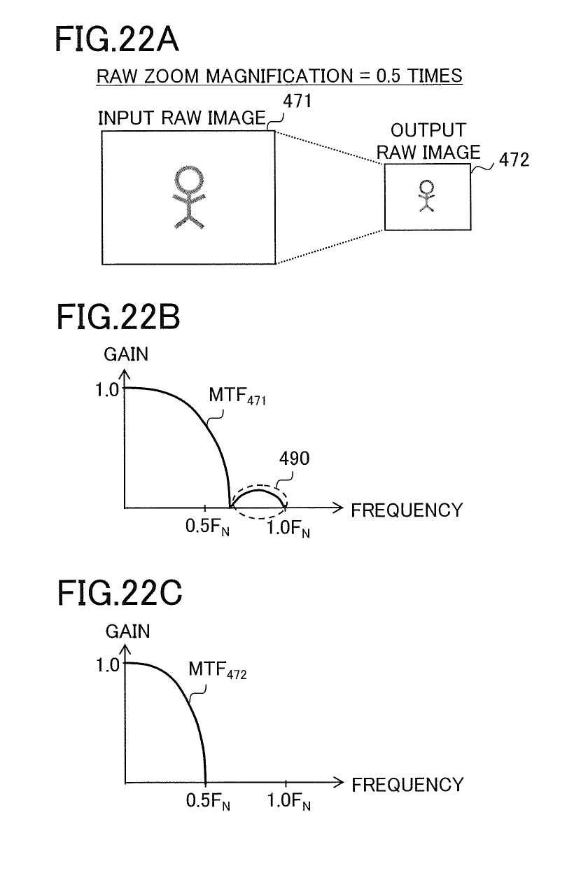

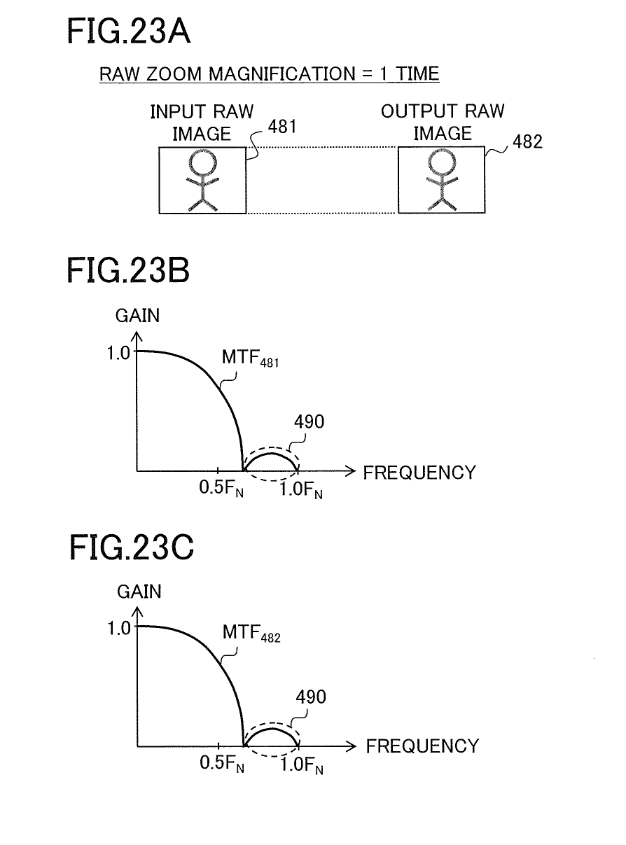

Consider now an input RAW image 471 and an output RAW image 472 as shown in FIG. 22A and an input RAW image 481 and an output RAW image 482 as shown in FIG. 23A. The input RAW images 471 and 481 are examples of the RAW image. It is here assumed that the input RAW images 471 and 481 each contain degradation due to blur. The output RAW image 472 is an image obtained by applying resolution conversion by the resolution conversion section 52 to the input RAW image 471 under the condition ZF_{RAW}=0.5. That is, the output RAW image 472 is a RAW image obtained by reducing the image size of the input RAW image 471 to one-half both in the horizontal and vertical directions. The output RAW image 482 is an image obtained by applying resolution conversion by the resolution conversion section 52 to the input RAW image 481 under the condition ZF_{RAW}=1.0. That is, the output RAW image 482 is identical with the input RAW image 481.

The curves MTF₄₇₁ and MTF₄₇₂ in FIGS. 22B and 22C represent the modulation transfer functions (MTFs) of the input RAW image 471 and the output RAW image 472 respectively. The curves MTF₄₈₁ and MTF₄₈₂ in FIGS. 23B and 23C represent the modulation transfer functions (MTFs) of the input RAW image 481 and the output RAW image 482 respectively. The symbol F_{N} represents the Nyquist frequency of the input RAW images 471 and 481.

Because of degradation due to blur, the maximum spatial frequency that can be included in the input RAW images 471 and 481 is lower than the Nyquist frequency F_{N}, and is about (0.7×F_{N}) in the examples shown in FIGS. 22B and 23B. The parts 490 of the MTF₄₇₁ and MTF₄₇₂ that lie above the frequency (0.7×F_{N}) correspond to the frequency components resulting from degradation, and do not reflect the subject (the same applies to the curve MTF₄₈₂).

When ZF_{RAW}=0.5, the number of pixels of the output RAW image equals one-half of that of the input RAW image both in the vertical and horizontal directions. Thus, the Nyquist frequency of the output RAW image 472 equals 0.5F_{N}.

On the other hand, when ZF_{RAW}=1.0, the number of pixels of the output RAW image equals that of the input RAW image both in the vertical and horizontal directions. Thus, the Nyquist frequency of the output RAW image 482 equals 1.0F_{N}. Even then, since the maximum spatial frequency that can be included in the input RAW image 481 is lower than the Nyquist frequency F_{N}, the maximum spatial frequency that can be included in the output RAW image 482 also is lower than the Nyquist frequency F_{N}.

Even in cases where degradation due to blur is involved, filters similar to those in Example 1 or 2 can be used in color interpolation processing, and this makes it possible to suppress aliasing and suppress lack in resolution (resolving power).

However, in a case where the RAW image contains degradation due to blur, in comparison with a case where the RAW image contains no degradation due to blur, the modulation transfer function is degraded, and the filter coefficients of filters can be determined with that degradation taken into consideration. Specifically, for example, the color interpolation section 51 may change the content of color interpolation processing between in a case (hereinafter referred to as case α_{BLUR}) where the RAW image contains degradation due to blur and in a case (hereinafter referred to as case α_{NONBLUR}) where the RAW image contains no degradation due to blur (that is, it may change the filter coefficients of the filters used in color interpolation processing between those cases). Between cases α_{BLUR} and α_{NONBLUR}, only part of the content of color interpolation processing may be changed, or the entire content of color interpolation processing may be changed.

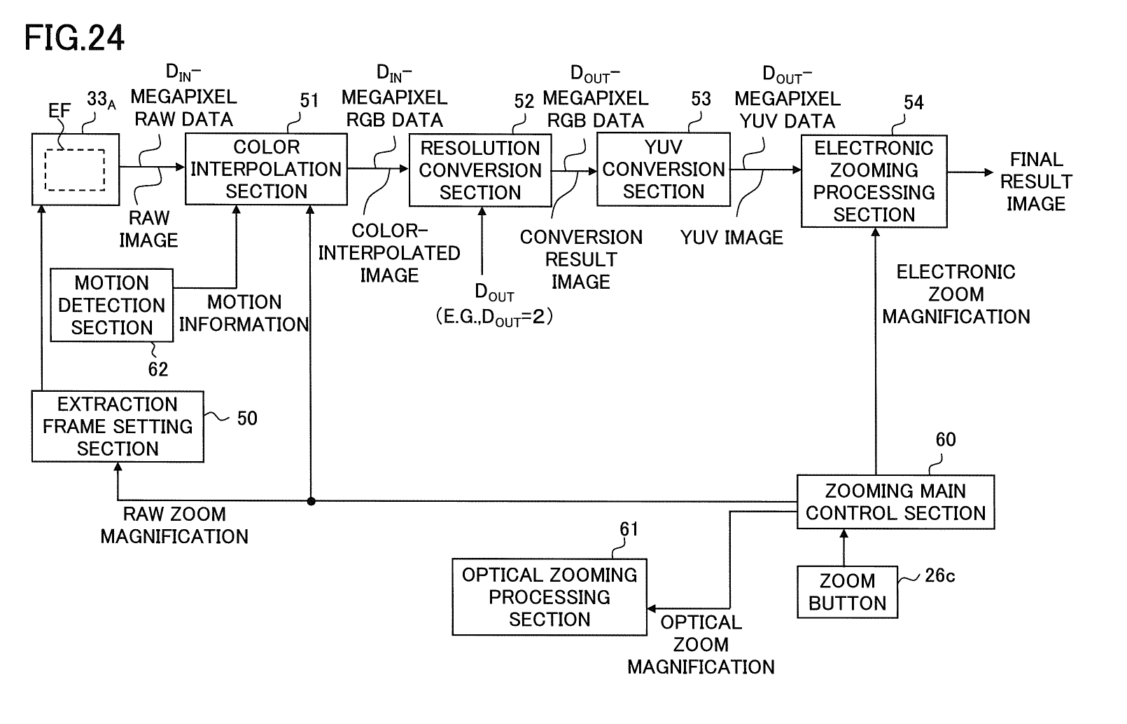

To achieve that, in Example 3, as shown in FIG. 24, a motion detection section 62 which generates motion information is added to the image-shooting device 1 so that, based on the RAW zoom magnification and the motion information, the content of color interpolation processing is determined. The block diagram in FIG. 24, as compared with the block diagram in FIG. 16, additionally shows the motion detection section 62.

The motion detection section 62 may be realized, for example, with a motion sensor which detects the motion of the image-shooting device 1. The motion sensor is, for example, an angular acceleration sensor which detects the angular acceleration of the image-shooting device 1, or an acceleration sensor which detects the acceleration of the image-shooting device 1. In a case where the motion detection section 62 is realized with a motion sensor, the motion detection section 62 generates motion information that represents the motion of the image-shooting device 1 as detected by the motion sensor. The motion information based on the detection result of the motion sensor at least includes motion magnitude information that represents the magnitude of the motion of the image-shooting device 1, and may also include motion direction information that represents the direction of the motion of the image-shooting device 1.

Instead, the motion detection section 62 may generate motion information based on photoreceptive pixel signals from the image sensor 33. In that case, the motion detection section 62 can, for example, derive, from the image data of two images (RAW images, color-interpolated images, conversion result images, YUV images, or final result images) obtained by shooting at two temporally close time points, an optical flow between those two images and then, from the optical flow, generate motion information including motion magnitude information and motion direction information as mentioned above.

In Example 3, the color interpolation section 51 controls the content of the filters used in color interpolation processing according to the RAW zoom magnification and the motion information, and thereby controls the spatial frequency characteristic of the image having undergone color interpolation processing.

For the sake of concrete description, consider now a case where the RAW data of a RAW image 600 (not shown) is fed to the color interpolation section 51. Based on the motion information obtained for the RAW image 600, the color interpolation section 51 checks which of case α_{BLUR} of case α_{NONBLUR} applies to the RAW image 600. For example, if the magnitude of the motion of the image-shooting device 1 as indicated by the motion information is greater than a predetermined level, the color interpolation section 51 judges case α_{BLUR} to apply to the RAW image 600 (that is, the RAW image 600 contains degradation due to blur); otherwise, the color interpolation section 51 judges case α_{NONBLUR} to apply to the RAW image 600 (that is, the RAW image 600 contains no degradation due to blur).

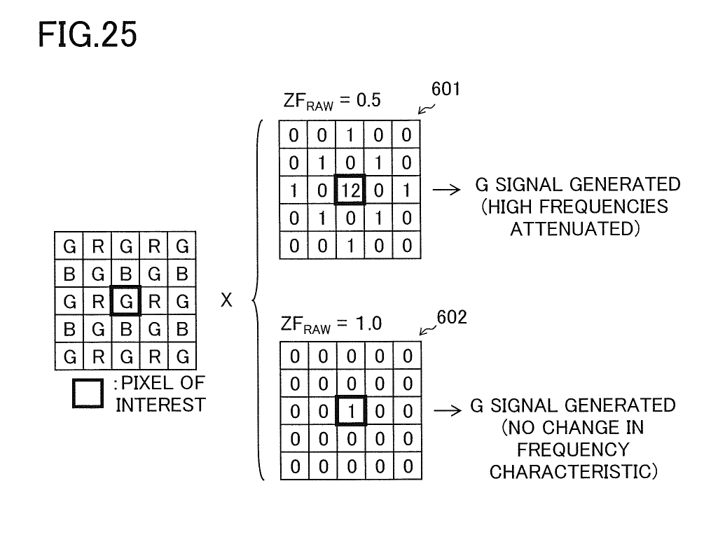

When case α_{NONBLUR} applies to the RAW image 600, the G signal of the target pixel is generated by the method described in connection with Example 1 (that is, through color interpolation processing using the filters 501 and 502 in FIG. 19A). On the other hand, when case α_{BLUR} applies to the RAW image 600, the G signal of the target pixel is generated through color interpolation processing using filters 601 and 602 in FIG. 25.

In case α_{BLUR}, the filter 601 is used when ZF_{RAW}=0.5 and in addition the pixel of interest is a green photoreceptive pixel, and the filter 602 is used when ZF_{RAW}=1.0 and in addition the pixel of interest is a green photoreceptive pixel. The filters 601 and 602 are each an example of filter FIL_{A} (see FIG. 12A). Except that the filter coefficient k_{A13} of the filter 601 is 12, the filter 601 is the same as the filter 501 in FIG. 19A. The filter 602 is the same as the filter 502 in FIG. 19A.

When the RAW image 600 obtained in cases α_{BLUR} and α_{NONBLUR} is identified by the symbols 600_{BLUR} and 600_{NONBLUR} respectively, then the modulation transfer functions of the RAW images 600_{BLUR} and 600_{NONBLUR} look like the curve MTF₄₇₁ in FIG. 22A and the curve MTF₄₅₁ in FIG. 17A respectively. Accordingly, the amount of high-frequency components contained in the RAW image 600_{BLUR} is low as compared with that contained in the RAW image 600_{NONBLUR}. Accordingly, under the condition ZF_{RAW}=0.5, the intensity of smoothing of the filter to be applied to the RAW image 600_{BLUR} need only be lower than that of the filter to be applied to the RAW image 600_{NONBLUR}. In other words, under the condition ZF_{RAW}=0.5, making the smoothing intensity of the filter applied to the RAW image 600_{BLUR} lower than that of the filter applied to the RAW image 600_{NONBLUR} helps suppress excessive smoothing. Excessive smoothing is undesirable. From this viewpoint, between cases α_{BLUR} and α_{NONBLUR}, the filters (501 and 601) used in color interpolation processing are made different. The intensity of smoothing through color interpolation processing using the filter 601 in FIG. 25 is lower than the intensity of smoothing through color interpolation processing using the filter 501 in FIG. 19A.

On the other hand, when ZF_{RAW}=1.0, spatial frequency components equivalent to the spatial frequency components of the RAW image can be expressed in the conversion result image, and therefore priority is given to suppression of lack in resolution (resolving power), and the same filters are used in cases α_{BLUR} and α_{NONBLUR} (see the filter 502 in FIG. 19A and the filter 602 in FIG. 25). The filters 602 and 502, however, may instead be different.

As the magnitude of the motion of the image-shooting device 1 increases, the degree of degradation due to blur increases, and the RAW image 600 tends to contain less of high-frequency components. Conversely, even in case α_{BLUR}, if the magnitude of the motion of the image-shooting device 1 is small, the RAW image 600 tends to contain high-frequency components in comparatively large amounts. Accordingly, in case α_{BLUR}, the color interpolation section 51 may perform color interpolation processing according to motion magnitude information while taking the RAW zoom magnification into consideration. For example, the content of color interpolation processing may be changed (that is, the filter coefficients of the filters used in color interpolation processing may be made different) between in a case where the magnitude of the motion of the image-shooting device 1 as indicated by the motion magnitude information is a first magnitude and in a case where it is a second magnitude. Here, the first and second magnitudes differ from each other.

While the above description discusses the filters used to generate a G signal when the pixel of interest is a green photoreceptive pixel, also to generate a G signal when the pixel of interest is a red or blue photoreceptive pixel, and to generate an R or B signal when the pixel of interest is a green, red, or blue photoreceptive pixel, on a principle similar to that described above, filters according to the RAW zoom magnification and the motion information are used in color interpolation processing.

### Example 4

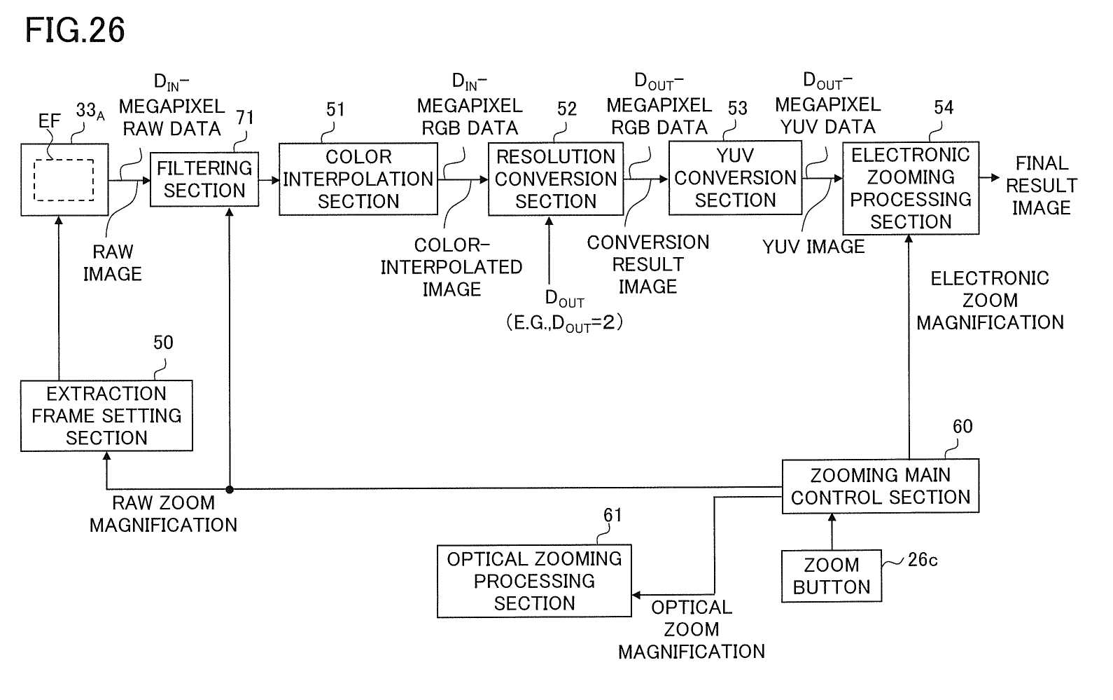

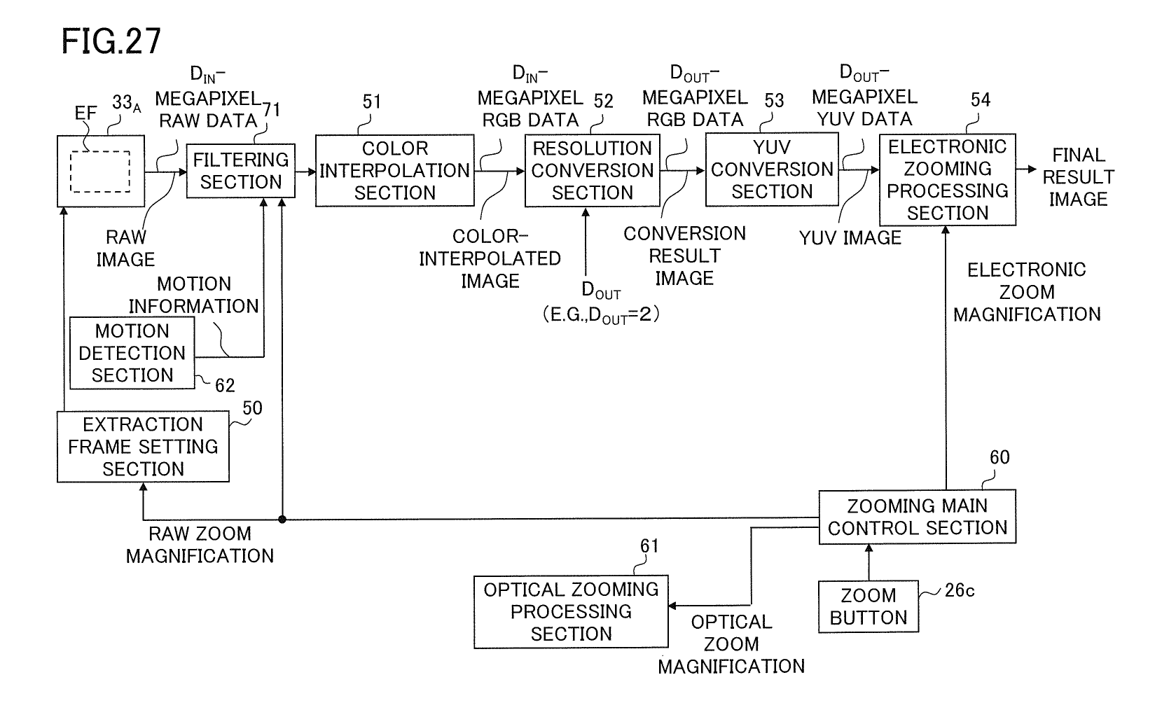

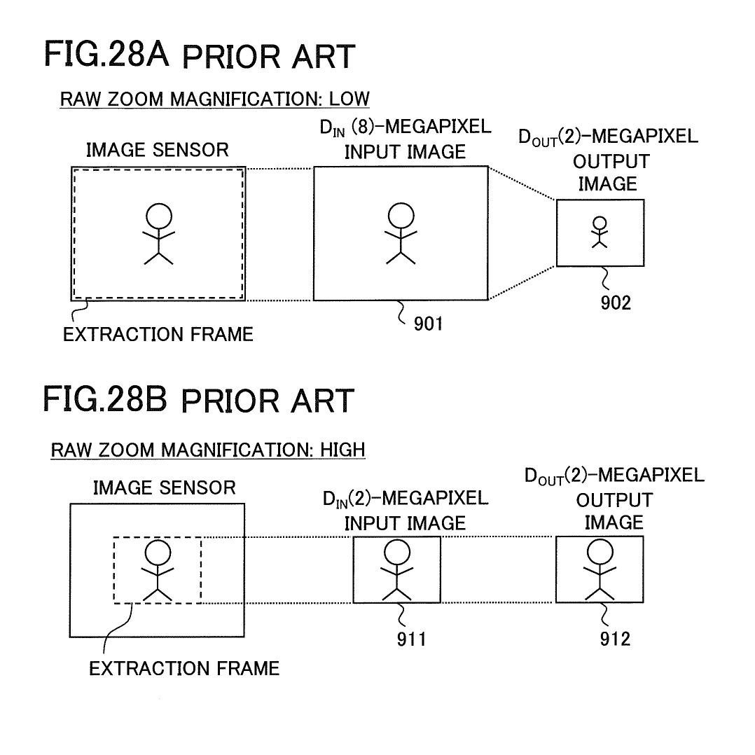

A fourth practical example (Example 4) will be described. The frequency characteristic control described above, including that discussed in connection with Examples 1 to 3, is realized through the control of the content of color interpolation processing. Frequency characteristic control equivalent to that described above may be realized through processing other than color interpolation processing. For example, configurations as shown in FIGS. 26 and 27 may be adopted in the image-shooting device 1. A filtering section 71 is provided, for example, in the video signal processing section 13 in FIG. 1.

In the configuration of FIG. 26 or 27, as the image data of the RAW image, D_{IN}-megapixel RAW data is fed from the photoreceptive pixels to the filtering section 71. The filtering section 71 performs filtering according to the RAW zoom magnification, or filtering according to the RAW zoom magnification and the motion information, on the RAW image (that is, on the D_{IN}-megapixel RAW data). The filtering in the filtering section 71 may be spatial filtering (spatial domain filtering), or may be frequency filtering (frequency domain filtering).

The color interpolation section 51 in FIG. 26 or 27 performs, on the RAW data fed to it via the filtering section 71, the basic color interpolation processing described with reference to FIG. 13A etc. The RAW data fed via the filtering section 71 is basically the RAW data as it is after having undergone the filtering by the filtering section 71, but the RAW data fed to the filtering section 71 may, as it is, be fed via the filtering section 71 to the color interpolation section 51. The D_{IN} megapixel RGB data obtained through the filtering by the filtering section 71 and the basic color interpolation processing by the color interpolation section 51 is fed, as the image data of the color-interpolated image, to the resolution conversion section 52. The operation of the blocks identified by the reference signs 50, 52 to 54, 60, and 61 is similar to that described above.

The filtering section 71 can control the spatial frequency characteristic of RAW data according to the RAW zoom magnification (in other words, according to the ratio D_{OUT} D_{IN}), or according to the RAW zoom magnification and the motion information. As the spatial frequency characteristic of RAW data is controlled, the spatial frequency characteristic of the conversion result image is controlled as well. Here, the filtering section 71 can, by changing the content of filtering according to variation in the ratio D_{OUT}/D_{IN}, change the spatial frequency characteristic of the conversion result image. Since variation in the RAW zoom magnification brings variation in the ratio D_{OUT}/D_{IN}, the filtering section 71 can be said to change the spatial frequency characteristic of the conversion result image in a manner interlocked with variation in the RAW zoom magnification or in the overall zoom magnification.

The filtering section 71 performs filtering according to the RAW zoom magnification, or filtering according to the RAW zoom magnification and the motion information, on the RAW image (that is, on the D_{IN}-megapixel RAW data) in such a way that the spatial frequency characteristics of the color-interpolated image obtained from the color interpolation section 51 and the conversion result image obtained from the resolution conversion section 52 are similar between in the configuration of Example 4 and in the configuration of Example 1, 2, or 3. To achieve that, the filtering section 71 can operate as follows.

For example, only when ZF_{RAW}<ZH_{TH1}, the filtering section 71 performs filtering with a low-pass filter on the RAW data fed to the filtering section 71; when ZF_{RAW}≧ZH_{TH1}, the filtering section 71 does not perform filtering but feeds the RAW data fed to the filtering section 71 as it is to the color interpolation section 51. Here, ZH_{TH1} is a predetermined threshold value fulfilling 0.5<ZH_{TH1}≦1.0, and for example ZH_{TH1}=1.0.

Instead, for example, the filtering section 71 always performs filtering with a low-pass filter on the RAW data fed to the filtering section 71 irrespective of the value of ZF_{RAW}, and increases the intensity of that low-pass filter as ZF_{RAW} decreases from 1 to 0.5. For example, reducing the cut-off frequency of the low-pass filter belongs to increasing the intensity of the low-pass filter.

It is also possible to vary the intensity of the low-pass filter according to motion information. Specifically, for example, the filtering section 71 may check which of cases α_{BLUR} and α_{NONBLUR} applies to the RAW image based on the RAW data fed to the filtering section 71 according to motion information, and change the content of filtering between those cases. More specifically, for example, the filtering section 71 makes the intensity of the low-pass filter applied to the RAW image in case α_{BLUR} lower than in case α_{NONBLUR} so that, under the condition ZF_{RAW}=0.5, an effect similar to that obtained in Example 3 is obtained.

The filtering by the filtering section 71 and the color interpolation processing by the color interpolation section 51 may be performed in the reversed order. That is, it is possible to first perform the color interpolation processing and then perform the filtering by the filtering section 71.

Example 4 offers benefits similar to those Examples 1, 2, or 3 offers. In Example 4, however, the filtering section 71 is needed separately from the color interpolation section 51. Accordingly, Examples 1 to 3, where frequency characteristic control can be performed according to the RAW zoom magnification etc. in color interpolation processing, are more advantageous in terms of processing speed and processing load.

### VARIATIONS AND MODIFICATIONS

The present invention may be carried out with whatever variations or modifications made within the scope of the technical idea presented in the appended claims. The embodiments described specifically above are merely examples of how the invention can be carried out, and the meanings of the terms used to describe the invention and its features are not to be limited to those in which they are used in the above description of the embodiments. All specific values appearing in the above description are merely examples and thus, needless to say, can be changed to any other values. Supplementary comments applicable to the embodiments described above are given in Notes 1 to 4 below. Unless inconsistent, any part of the comments can be combined freely with any other.

Note 1: In the configuration shown in FIG. 16 etc., color interpolation processing is performed first, and then resolution conversion is performed to convert the amount of image data from D_{IN} megapixels to D_{OUT} megapixels; the two processing may be performed in the reversed order. Specifically, it is possible to first convert D_{IN}-megapixel RAW data into D_{OUT}-megapixel RAW data through resolution conversion based on the RAW zoom magnification (or the value of D_{OUT}) and then perform color interpolation processing on the D_{OUT}-megapixel RAW data to generate D_{OUT}-megapixel RGB data (that is, the image data of the conversion result image). In practice, resolution conversion and color interpolation processing can be performed simultaneously.

Note 2: In the configuration shown in FIG. 16 etc., after RGB data is generated, YUV conversion by the YUV conversion section 53 is performed. In a case where YUV data is to be eventually generated, YUV data may be generated directly through color interpolation processing.

Note 3: The image-shooting device 1 shown in FIG. 1 may be configured as hardware, or as a combination of hardware and software. In a case where the image-shooting device 1 is configured as software, a block diagram showing those blocks that are realized in software serves as a functional block diagram of those blocks. Any function that is realized in software may be prepared as a program so that, when the program is executed on a program execution device (for example, a computer), that function is performed.

Note 4: For example, the following interpretation is possible:

The image-shooting device 1 is provided with a specific signal processing section which, through specific signal processing, generates the image data of an output image from photoreceptive pixel signals within an extraction frame EF on the image sensor 33. A conversion result image, a YUV image, or a final result image is an example of the output image. Specific signal processing is processing performed on the photoreceptive pixel signals within the extraction frame EF, and on a signal based on the photoreceptive pixel signals within the extraction frame EF, to generate the image data of the output image from the photoreceptive pixel signals within the extraction frame EF.

The specific signal processing section includes a color interpolation section 51 and a resolution conversion section 52, or includes a filtering section 71, a color interpolation section 51, and a resolution conversion section 52, and may additionally include a YUV conversion section 53, an electronic zooming processing section 54, and a filtering section 71. Thus, in Examples 1 to 3, the specific signal processing includes color interpolation processing and resolution conversion, and in Example 4, the specific signal processing includes filtering (the filtering by the filtering section 71), color interpolation processing, and resolution conversion. Although not shown in FIG. 16 etc., specific signal processing may further include noise reduction processing etc. The specific signal processing section can control the spatial frequency characteristic of the output image by controlling the specific signal processing according to the ratio D_{OUT}/D_{IN}. More specifically, the special signal processing section can change the spatial frequency characteristic of the output image by changing the content of the specific signal processing (the content of color interpolation processing or the content of filtering) in accordance with variation in the ratio D_{OUT}/D_{IN}.

What is claimed is:

1. An image-shooting device comprising:
an image sensor having a plurality of photoreceptive pixels; and
a signal processing section which generates image data of an output image from photoreceptive pixel signals within an extraction region on the image sensor,
wherein the signal processing section controls a spatial frequency characteristic of the output image according to an input pixel number, which is a number of photoreceptive pixels within the extraction region, and an output pixel number, which is a number of pixels of the output image.

2. The image-shooting device according to claim 1, wherein the signal processing section changes the spatial frequency characteristic of the output image in accordance with variation in a ratio of the output pixel number to the input pixel number.

3. The image-shooting device according to claim 2, wherein
the image sensor is a single-panel image sensor having color filters of a plurality of colors provided for the plurality of photoreceptive pixels,
the signal processing section generates the image data of the output image by performing color interpolation processing on the photoreceptive pixel signals within the extraction region such that the pixels of the output image are each assigned a plurality of color signals, and
the signal processing section changes the spatial frequency characteristic of the output image by changing content of the color interpolation processing according to the variation in the ratio.

4. The image-shooting device according to claim 3, wherein
the signal processing section
performs first color interpolation processing as the color interpolation processing when the ratio is a first ratio and
performs second color interpolation processing as the color interpolation processing when the ratio is a second ratio greater than the first ratio, and
intensity of smoothing through the first color interpolation processing is higher than intensity of smoothing through the second color interpolation processing, or intensity of edge enhancement through the second color interpolation processing is higher than intensity of edge enhancement through the first color interpolation processing.

5. The image-shooting device according to claim 1, further comprising an extraction region setting section which sets size of the extraction region according to a specified zoom magnification, wherein
as the zoom magnification varies, the size of the extraction region varies, and
the signal processing section changes the spatial frequency characteristic of the output image in a manner interlocked with variation in the zoom magnification.

6. The image-shooting device according to claim 1, wherein
the signal processing section controls the spatial frequency characteristic of the output image according to the input pixel number and the output pixel number and motion information based on the photoreceptive pixel signals or motion information based on a result of detection by a sensor which detects motion of the image-shooting device.
